(19) United States
(12) Patent Application Publication
(10) Pub. No.: US 2022/0272033 A1
(43) Pub. Date: Aug. 25, 2022

(54) GROUP-BASED SERVICE INSERTION FOR ENTERPRISE PRIVATE NETWORKS USING LOCATOR ID / SEPARATION PROTOCOL (LISP) CONTROL PLANE

(71) Applicant: Cisco Technology, Inc., San Jose, CA (US)

(72) Inventors: Prakash Jain, Fremont, CA (US); Sanjay Kumar Hooda, Pleasanton, CA (US); Rajeev Kumar, Sunnyvale, CA (US); Saravanan Radhakrishnan, Bangalore (IN); Solomon T. Lucas, Sunnyvale, CA (US); Ramesh Yeevani-Srinivas, Fremont, CA (US)

(21) Appl. No.: 17/185,279

(22) Filed: Feb. 25, 2021

(51) Int. Cl. H04L 12/717; H04L 12/725; H04L 12/715; H04L 12/713; H04L 12/26; H04L 12/46

(52) U.S. Cl. CPC H04L 45/42; H04L 45/302; H04L 45/64; H04L 45/586; H04L 43/0882; H04L 12/4633

(57) ABSTRACT

A map server/map resolver (MS/MR) of a Locator ID Separation Protocol (LISP) control plane for an enterprise private network for group-based service insertion is described. The MS/MR may facilitate communications from a first host having a first endpoint ID (EID) and located at a first tunnel router having a first routing locator (RLOC), to a second host having a second EID and located at a second tunnel router having a second RLOC. The MS/MR receives, from the first tunnel router, a map request for requesting an EID-to-RLOC mapping associated with the second EID and including a group identifier. The MS/MR selects a service insertion policy including an address of a service border router for a service that is registered with the MS/MR, and responds with a map reply including the address for populating an overlay route for forwarding communications via the service border router for insertion of the registered service.

### TECHNICAL FIELD

The present disclosure relates generally to telecommunications systems, and more particularly to techniques and mechanisms for a group-based service insertion for enterprise private networks for traffic flows, such as Fifth Generation (5G) traffic flows for remote hosts, using a Locator ID/Separation Protocol (LISP) control plane.

### BACKGROUND

Service insertion poses challenges in enterprise private networks when multiple services need to be applied in relation to a particular traffic flow. Services may include firewall or security services, billing or accounting services, service level agreement (SLA) monitoring services, Quality of Service (QoS) policy services, and the like. These challenges become more prevalent in relation to enterprise software-defined access (SDA) or software-defined networking (SDN) fabrics, which are overlay-based and utilize group-based policy and segmentation. Service insertion in enterprise SDA/SDN fabrics is problematic due to the use of traditional service routers that would need to apply the services. Specifically, traditional service routers do not readily support the appropriate encapsulation and tagging (e.g. security group tags or “SGTs”) associated with overlay headers of data packets for appropriate processing.

Traditionally, access control list (ACL)/policies (e.g. for policy-based routing) are used on an edge or border router to redirect traffic to service routers. However, this approach does not scale well as the number of flows, groups, and/or subnets become larger, especially in relation to security services where the traffic needs to be routed to a particular service router (e.g. a firewall). In addition, ACLs consume a great deal of hardware or forwarding resources which may already be scarce, for example, on relatively low-end switches or routers.

In a solution, fabric routers that connect to services should be able to differentiate between pre-service and post-service traffic, so that traffic does not get routed back to apply same service again (e.g. looping) after post-service processing. As some services may fail, dynamic service updating is also a feature to consider, and such updating should be transparent to users as the system moves traffic from old to new service instances. Load-balancing to service instances (e.g. hash-based load balancing) should also be achievable in such a solution.

Even further, with the promise of Fifth Generation (5G) connectivity to provide high-speed direct communication via a shared 5G backbone network, specific services may need to be inserted in relation to 5G traffic flows that enter into or exit from an enterprise private network. Multiple services, such as security services and/or policy services, may need to be applied to 5G traffic flows from 5G endpoints.

Service insertion that is not bound by topological restrictions may be useful or essential for such communications. Consider, for example, the current working environment where in-person meetings are restricted (e.g. COVID-19 restrictions) and members of an organization are connected remotely. Here, an architecture that allows for dynamic service insertion could make the network truly location-independent (e.g. without requiring member traffic to be brought back into the enterprise private network). It would be advantageous if the general solution to enterprise SDA/SDN networks would inherently provide a solution in this environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B are illustrative representations of a network infrastructure arrangement of a network overlay fabric, where each one of a plurality of tunnel routers may be configured to process communications in accordance with a tunneling protocol to provide network overlay tunnels in the network overlay fabric to facilitate virtual private networks (VPNs) for hosts, where the tunneling protocol is Locator ID/Separation Protocol (LISP) and a mapping system (or map server/map resolver or “MS/MR”) may be used for storing and providing host-to-router mappings for the communications;

FIG. 1C is an illustrative representation of the network infrastructure arrangement of FIG. 1B, where a complex routing protocol such as border gateway protocol (BGP) may be required between the mapping system and one or the tunnel routers to facilitate connectivity to an external communication network in accordance with conventional techniques;

FIG. 1D is an illustrative representation of the network infrastructure arrangement of FIG. 1C, where a publish-subscribe-based mechanism may be utilized between the mapping system and the tunnel router to provide an auto-configurable, external network connectivity, without use of the complex routing protocol of FIG. 1C;

FIG. 1E is an illustrative representation of functional block diagrams of the mapping system and the tunnel router having the publish-subscribe-based mechanism for the auto-configurable, external network connectivity;

FIG. 2A is a message flow diagram for describing a general method of processing communications to facilitate access to extranet shared services in a network overlay fabric, such as the network overlay fabric in the network infrastructure arrangements in FIGS. 1A, 1B, 1D, and 1E;

FIG. 2B is a message flow diagram for describing a method for use in a network overlay fabric for processing communications to facilitate a secure group-based access to shared services in an external (e.g. extranet) network, e.g. in the network overlay fabric in the network infrastructure arrangements in FIGS. 1A, 1B, 1D, and 1E;

FIG. 3 is a process flow diagram for describing publish-subscribe-based method to provide an auto-configurable, external network connectivity in a network overlay fabric, such as the network overlay fabric in the network infrastructure arrangements in FIGS. 1D and 1E;

FIGS. 4A-4B are flowcharts for describing methods for use in group-based service insertion for enterprise private networks using a LISP control plane according to some implementations of the present disclosure;

FIG. 5A is a network architecture with message flow for facilitating a group-based service insertion, with L3 forwarding, using the LISP control plane according to some implementations of the present disclosure;

FIG. 5B is a network architecture with message flow for facilitating a group-based service insertion, with L2 forwarding, using the LISP control plane according to some implementations of the present disclosure;

FIGS. 6A-6B are example message formats for encapsulation and overlay routing and encapsulation which may be utilized;

FIG. 7 is a network architecture which includes a shared Fifth Generation (5G) backbone network including a plurality of network routers that may interconnect a plurality of 5G mobile core networks; and

FIG. 8 illustrates a hardware block diagram of a computing device that may perform functions associated with operations discussed herein.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Techniques and mechanisms for “dynamic” group-based service insertion for enterprise private networks for traffic flows using Locator ID/Separation Protocol (LISP) control plane or Map Server/Map Resolver (MS/MR) are described herein. Such techniques and mechanisms may be suitable for use in facilitating virtual enterprise networking with remote access and Fifth Generation (5G) traffic flows.

In one illustrative example, a method may be performed by one or more computing devices (a “computing device”) which implement a MS/MR of a LISP control plane for use in an enterprise private network. In some implementations, the enterprise private network may comprise a software-defined access (SDA) or software-defined networking (SDN) fabric. The computing device may be configured to facilitate communications from a first host that is located for communication via a first tunnel router to a second host that is located for communication via a second tunnel router. The first and the second hosts are assigned with first and second endpoint IDs (EIDs), respectively, and the first and the second tunnel routers are assigned with first and second routing locators (RLOCs), respectively.

In the method, the computing device may receive, from the first tunnel router, a message which indicates a map request for requesting an EID-to-RLOC mapping associated with the second EID, which is triggered in response to the first tunnel router receiving initial traffic of the communications from the first host. The computing device may select, from a policy database, the service insertion policy based on at least the second EID or a group identifier in the message. The service insertion policy may include an address of a service border router for a service that is registered with the MS/MR. The service may be one of firewall or security service, a billing or an accounting service, a service level agreement (SLA) monitoring service, or a Quality of Service (QoS) policy service, as a few examples. The computing device may send, to the first tunnel router, a message which indicates a map reply and includes the address of the service border router, for populating an overlay route in the first tunnel router to forward the communications via the service border router for insertion of the service.

On the other hand, when no service insertion policy exists, the computing device may select, from the mapping database, the second RLOC of the second tunnel router based on the second EID. The computing device may send, to the first tunnel router, the message which indicates the map reply and includes the second RLOC of the second tunnel router, for populating the route in the first tunnel router to forward the communications to the second tunnel router to the second host.

Prior to receiving the initial traffic of the communications from the first host, the computing device may receive, from the service border router, a message which indicates a service registration for registering the service with the MS/MR. In some implementations, service registration is performed by each one of a plurality of services available via the service border router. Here, the selecting of the service insertion policy may comprise selecting the service insertion policy from a plurality of service insertion policies respectively associated with the plurality of services registered with the MS/MR. In some implementations, the selecting of the service insertion policy from the plurality of service insertion policies may be performed according to a service ID associated with the service insertion policy or service.

In some implementations, the group identifier comprises a source group tag (SGT), and the service insertion policy may be selected based on at least the SGT and a destination group tag (DGT) associated with the second host. Here, the computing device may send, to the first tunnel router, the message which indicates the map reply and includes the address of the service border router, to further include the SGT, the DGT, and a group policy for application at the first tunnel router.

In some implementations, the service insertion policy further includes an instance ID associated with a virtual routing and forwarding (VRF) at the service border router. Here, the message which indicates the map reply may include the address of the service border router, a virtual network identifier of a virtual private network associated with the VRF, and the group identifier, for populating the overlay route in the first tunnel router to forward the communications, with encapsulation of the virtual network identifier and the group identifier, via the service border router for insertion of the service.

In some implementations, the service insertion policy further includes a virtual local area network (VLAN) ID of a VLAN. Here, the message which indicates the map reply may include the address of the service border router, the VLAN ID, and the group identifier, for populating the overlay route in the first tunnel router to forward the communications, with encapsulation of the VLAN ID and the group identifier, via the service border router for insertion of the service.

Subsequently (i.e. after processing associated with the service), the computing device may receive, from the service border router, a message which indicates another map request for requesting an EID-to-RLOC mapping associated with the second EID. The computing device may select, from a mapping database, the second RLOC of the second tunnel router based on the second EID. The computing device may send, to the service border router, a message which indicates another map reply and includes the second RLOC of the second tunnel router, for populating an overlay route in the service border router to forward the communications via the second tunnel router to the second host.

Accordingly, in some implementations, the computing device may select either the service insertion policy or the second RLOC of the second tunnel router, based on identifying an indication (e.g. a message indication) of whether the message which indicates the map request or the other map request is sent from the first tunnel router or the service border router.

When the second host is a 5G endpoint which is located for communication via the second tunnel router that is external to the enterprise private network, the computing device may receive, from the service border router, a message which indicates another map request for requesting an EID-to-RLOC mapping associated with the second EID. The computing device may send, to the service border router, a message which indicates another map reply and include a third RLOC of a border router, for populating an overlay route in the border router to the second host via the second tunnel router that is external to the enterprise private network.

In some implementations, the computing device may comprise one or more processors, one or more interfaces to connect in a network for SDA or SDN, and one or more memory elements for storing instructions executable on the one or more processors for operation as the MS/MR of the LISP control plane as described. In some preferred implementations, the computing device may implement the MS/MR of the LISP control plane as well as tunnel router functionality on the same device (with logical separation). In some implementations, the method may be embodied in a computer program product comprising a non-transitory computer readable medium and instructions stored on the non-transitory computer readable medium, where the instructions are executable by one or more processors of a computing device for operation as the MS/MR of the LISP control plane as described.

One or more advantages may be realized depending on the implementation. When a service (or its associated path) becomes unavailable or is taken off-line, the service border router may send a message for service deregistration of the service. When the service (or its associated path) becomes available again or is brought back on-line, the service border router may again send a message for service registration for registration of the service. When a new or updated service becomes available, the service border router may send a message for service registration for registration of the new or updated service. As is apparent, the MS/MR may be updated dynamically for indicating the availability or non-availability of services. A plurality of service routers/service instances associated with a (e.g. single) service may register/deregister for load balancing and/or redundancy for the service.

More detailed and alternative techniques and implementations are provided herein as described below.

### Example Embodiments

As described earlier above in the Background section, service insertion poses challenges in enterprise private networks when multiple services need to be applied in relation to a particular traffic flow. These challenges become more prevalent in relation to enterprise software-defined access (SDA) or software-defined networking (SDN) fabrics, which are overlay-based and utilize group-based policy and segmentation.

In general, a network overlay may employ software virtualization to create an additional layer of network abstraction on top of a physical network. Such a network overlay may be used to provide virtual private networking (VPN) for hosts in a network. Specifically, routers in the network may be configured to operate using a network overlay protocol to facilitate VPN networking. The protocol may be, for example, Locator ID/Separation Protocol (LISP); however, other suitable alternatives may be utilized, such as Border Gateway Protocol (BGP) Ethernet VPN (EVPN) (BGP-EVPN), Virtual Extensible LAN (VXLAN), Enhanced VLAN (EVLAN), or Identifier Locator Addressing (ILA). Here, the routers create and maintain multiple VPN instances comprising forwarding tables for the routing of user plane traffic associated with different VPNs.

The technology utilized may be based on or referred to as virtual routing and forwarding (VRF) technology. Such network virtualization creates multiple, logically-separated topologies across one common physical infrastructure. Network reachability within a VPN is typically restricted to the addresses of the end-points that are members of the VPN. Such a level of segmentation is useful in providing fault isolation, enforcing access-control restrictions, enabling the use of a single network by multiple tenants, and scoping network policy per VPN.

In general, LISP is a network architecture and protocol that uses multiple namespaces or network addresses for identifying and locating network nodes, such as an identity namespace or address space and a location namespace or address space. This is distinguishable from a conventional network that may only use a single namespace or address space (e.g. Internet Protocol “IP” addresses) for both identifying and locating network nodes. LISP can assign addresses in the identity namespace (e.g., Endpoint Identifier or “EID” namespace) to hosts, and addresses in the location name space (e.g., Routing Locator or “RLOC” namespace) to network devices. LISP can maintain a directory of identifiers and their corresponding locations (e.g., a directory mapping of the EID namespace to the RLOC namespace). LISP, as a protocol, can define the signaling to populate this directory, keep it updated, and enable network devices to consult the directory and resolve the locations of EIDs of interest. Routing and forwarding of data packets can continue to be the responsibility of traditional routing protocols in the RLOC namespace but LISP can augment these protocols by adding another namespace to enable functionality that may otherwise be difficult to achieve natively in traditional routing protocols. Because of the separation of the namespaces and their loose coupling with basic routing and forwarding, the definition of EIDs and RLOCs can extend beyond addressing to include policy semantics and other metadata to provide features such as host mobility, large-scale segmentation, traffic engineering, location-aware policies, location tracking services, and so forth. A WAN platform that can integrate LISP (or similar technology for separating host identifier information and host location information) across multiple LANs can take further advantage of the decoupling of host identity and location.

Again, LISP provides two namespaces: an EID namespace and a RLOC namespace. A host (e.g. a computer or a server) may be associated with an EID (e.g. an IP address), whereas a router may be associated with an RLOC (e.g. an IP address). A router may be an ITR, an ETR, or a combination thereof (ITR+ETR=XTR). A LISP Mapping System (e.g. including a mapping server and/or database) maps EIDs to RLOCs. Either the EID space, the RLOC space, or both, may be segmented. The LISP Mapping System can be used to map a segmented EID address space to the RLOC space. When the EID namespace is segmented, a LISP Instance-ID (IID) is encoded in both the data plane and the control plane to provide segmentation as well as to disambiguate overlapping EID Prefixes. This allows multiple VRFs to share a common routing locator network while maintaining EID prefix segmentation.

In a LISP VPN, XTRs that are members of the VPN should be configured with a forwarding context (e.g. a VRF) and the associated IID for the VPN. Based on this configuration, the ETRs must register the EIDs within the forwarding context as Extended EIDs (IID+EID). The LISP mapping system consolidates the registrations from all the ETRs in the VPN and builds a mapping database for the VPN. ITRs that are members of the VPN will do forwarding lookups in the forwarding context where traffic was received. Upon a cache miss within the forwarding context, the ITR will issue a Map-Request for the destination EID and include the VPN's BD. This information will be encoded as an Extended EID (IID+EID) in the Map-Request issued. The BD to associate with the EID in this Map-request is derived from the configuration of the VPN's forwarding context (in which the traffic was received). The Mapping System should reply to the Map Request with a Mapping for the Extended EID (IID+EID), the IID of the Extended EID should be used to identify the forwarding context in which the Mapping received should be cached. Once a mapping has been cached in the VPN's forwarding context, the ITR may encapsulate the traffic towards the RLOC in the mapping. The IID corresponding to the VPN's forwarding context must be included in the IID field of the data plane header. When the encapsulated traffic is received at the ETR, the encapsulation header is removed and the IID received in the header is used to identify the forwarding context to use to do a forwarding lookup for the decapsulated traffic. Protocols associated with these technologies are described in various published documents, including The Locator/ID Separation Protocol (LISP), Internet Engineering Task Force (IETF), Request for Comments (RFC): 6830; D. Farinacci et al., January 2013.

Extranet VPN support may be provided using LISP. Typically, an extranet allows for communication across multiple VPNs, subject to policy constraints, in which each “subscriber” VPN may communicate with a “provider” VPN to access a shared service but be restricted from communicating with each other via the provider VPN. LISP specifically allows for distributed extranet VPN support. Here, as the extranets are not centralized but rather distributed to ITRs, there is no centralized point of failure. For extranet routes, an ITR may operate to encapsulate user plane traffic associated with the IID corresponding to the VPN connected to the ETR. Extranet routes may be installed at the ITR with the IID corresponding to the destination VPN.

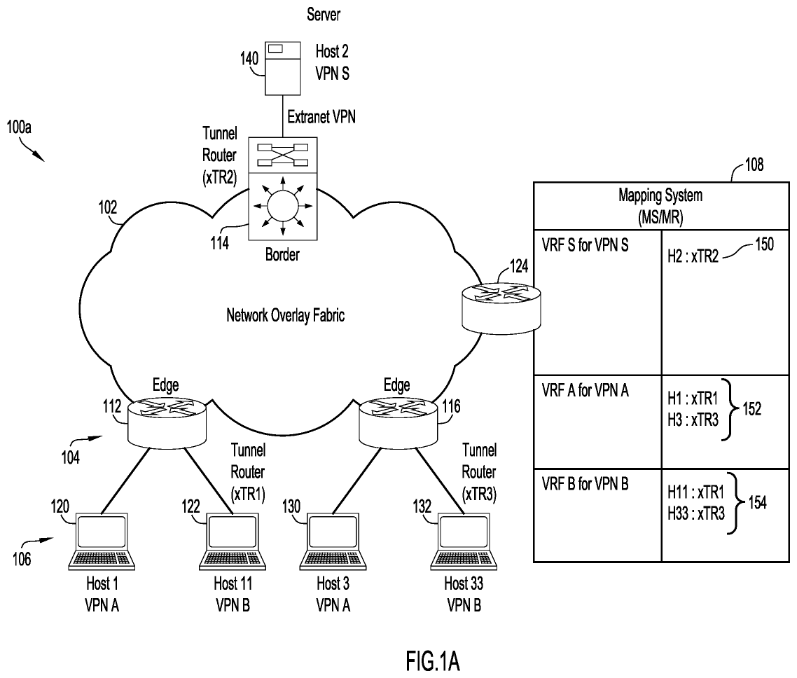

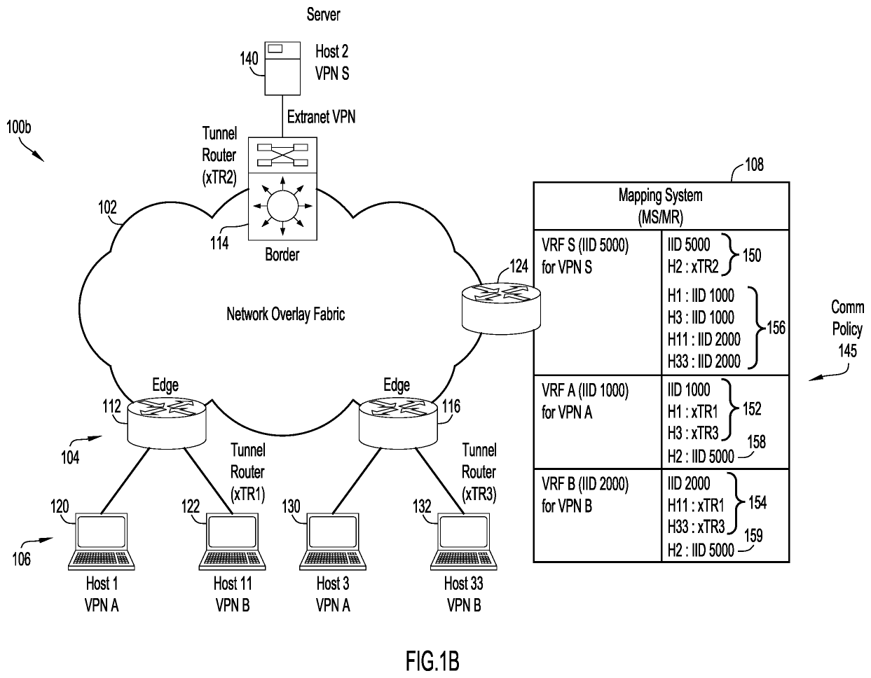

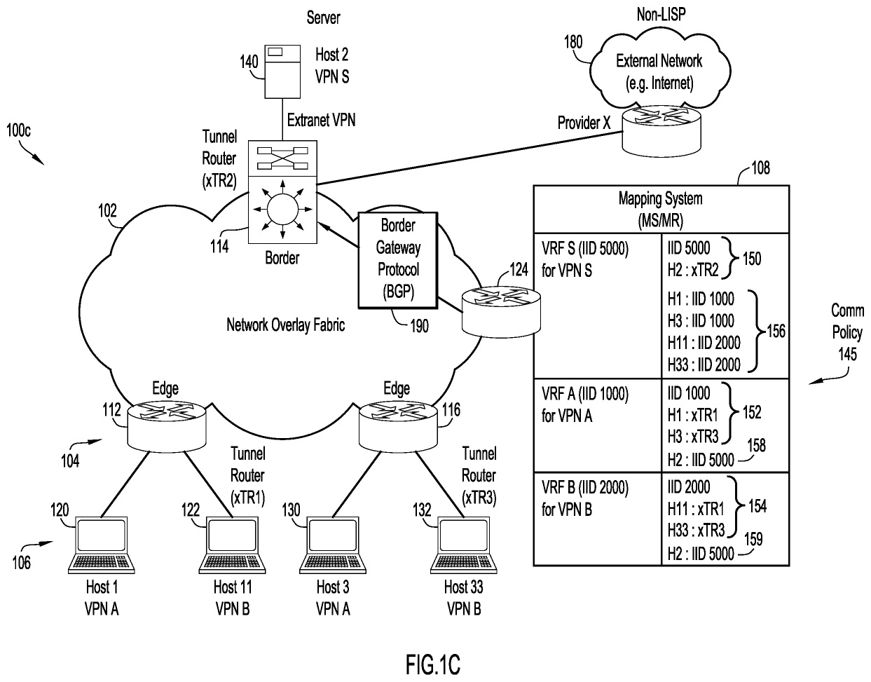

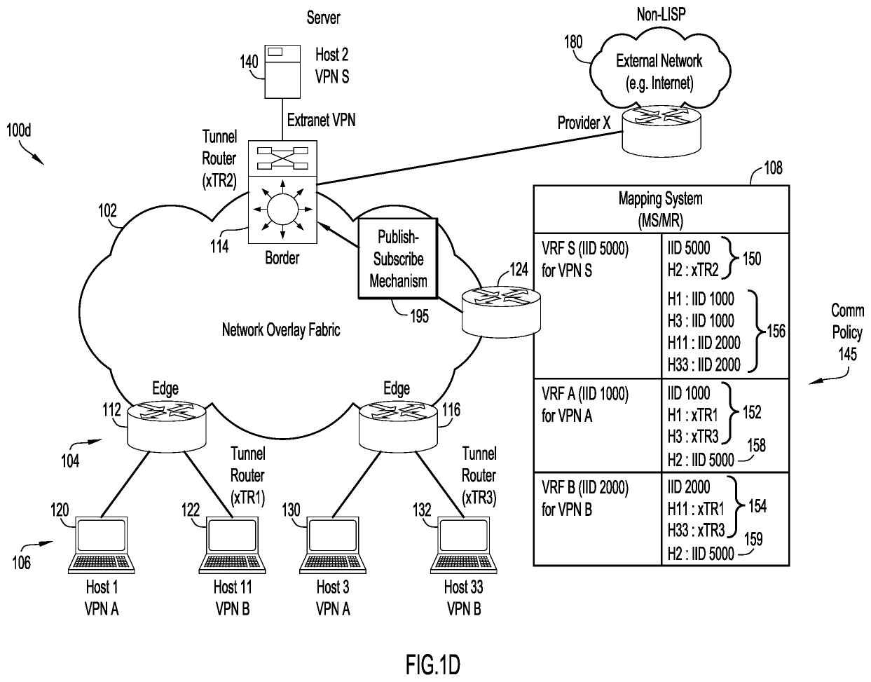

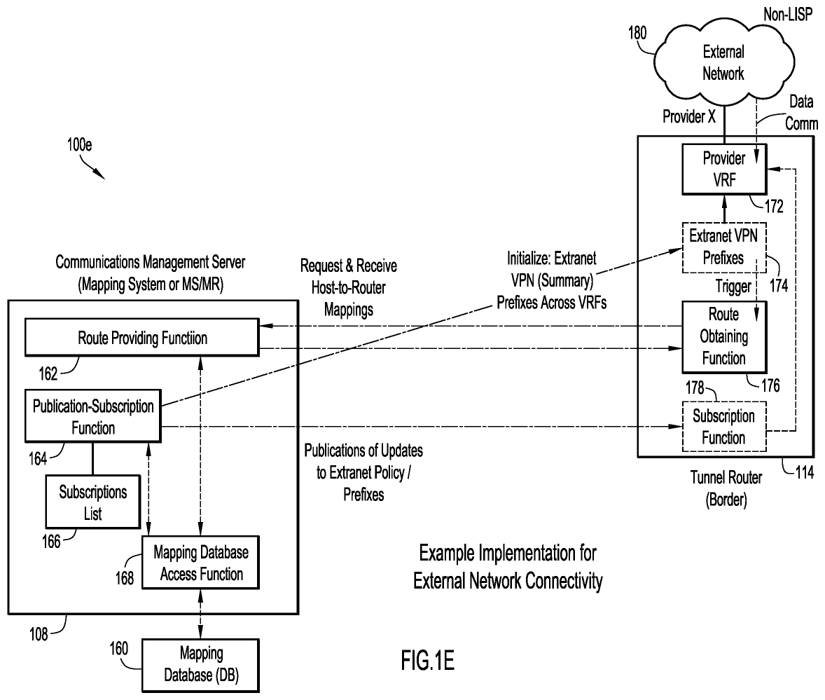

To provide better context of the general environment within which the present techniques and mechanisms of the present disclosure may be practiced, description associated with the network infrastructure arrangements, functional block diagrams, and message flow diagrams of FIGS. 1A-1E, 2A-2B, and 3 are provided.

FIG. 1A is an illustrative representation of a network infrastructure arrangement 100A in one or more networks of a network overlay fabric 102, wherein tunneling protocols are utilized to establish and maintain network overlay tunnels to provide VPNs. Network overlay fabric 102 may include a plurality of routers 104. The plurality of routers 104 may be and/or be referred to as tunnel routers, each of which may be configured to perform a network overlay or “tunneling” protocol for establishing and maintaining network overlays or tunnels across the one or more networks of network overlay fabric 102. The plurality of routers 104 illustrated in FIG. 1 include a tunnel router 112, a tunnel router 114, and a tunnel router 116. Tunnel routers 112 and 116 may be referred to as tunnel endpoints or “edge” tunnel routers, whereas tunnel router 114 may be referred to as a “border” tunnel router.

A plurality of hosts 106 may be connected in the one or more networks of network overlay fabric 102. The plurality of hosts 106 illustrated in FIG. 1 include a host 120 (“host 1” or H1) and a host 122 (“host 11” or H11) connected via tunnel router 112, a host 140 (“host 2” or H2) connected via tunnel router 114, and a host 130 (“host 3” or H3) and a host 132 (“host 33” or H33) connected via tunnel router 116. As indicated in FIG. 1, hosts 120 and 130 are members of the same VPN, “VPN A” associated with VRF A. Similarly, hosts 122 and 132 are members of the same VPN, “VPN B” associated with VRF B. Host 140 may be a member of “VPN S” associated with VRF S. In some implementations, host 140 may be a shared server which is accessible to hosts 120, 122, 130, and 132 via VPN S, which may be a remote extranet VPN.

One or more mapping servers or systems (e.g. mapping system 108) may be connected in the one or more networks of network overlay fabric 102. Mapping system 108 may be more generally referred to as a communications management server or entity. Hosts 106 may register with mapping system 108 to provide their (route/router) locations in the network, for example, in the form of host-to-router mappings. Mapping system 108 may be or include, for example, a MS/MR.

Registrations of hosts 106 in mapping system 108 are indicated in FIG. 1A. More specifically, registrations associated with VPN A/VRF A includes host-to-router mappings 152 between host 120 and tunnel router 112 (i.e. H1: xTR1) and between host 130 and tunnel router 116 (i.e. H3: xTR3); registrations associated with VPN B/VRF B includes host-to-router mappings 154 between host 122 and tunnel router 112 (i.e. H11: xTR1) and between host 132 and tunnel router 116 (i.e. H33: xTR3); and a registration associated with VPN S/VRF S includes a host-to-router mapping 150 between host 140 and tunnel router 114 (i.e. H2: xTR2).

FIG. 1B is an illustrative representation of a network infrastructure arrangement 100B which is the same as network infrastructure arrangement 100A of FIG. 1A, but further includes policy data 145 of a communication policy to further facilitate communications. Policy data 145 may be or include a cross-VRF communication policy. In FIG. 1B, the same registrations of hosts 106 as well as their host-to-router mappings in mapping system 108 of FIG. 1A are indicated. Hosts 120 and 130 are members of the same VPN, which is VPN A associated with VRF A and an Instance ID (IID) of 1000; an extranet policy 158 for VPN A allows communication with host 140 associated with IID of 5000 (H2: IID 5000). Hosts 122 and 132 are members of the same VPN, which is VPN B associated with VRF B and an IID of 2000; an extranet policy 159 for VPN B allows communication with host 140 associated IID of 5000 (H2: IID 5000). On the other hand, host 140 may be a member of VPN S associated with VRF S and an IID of 5000; an extranet policy 156 for VPN S allows communication with hosts 120 and 130 associated with IID of 1000 (H1: IID 1000; H3: IID 1000) and hosts 122 and 132 associated with IID of 2000 (H11: IID 2000; H33: IID 2000).

In FIG. 1B (as well as in FIGS. 1C-1D described later below), what is shown is merely an illustrative example using a single table with host entries pointing to extranet IIDs. In another illustrative example, a more efficient implementation may be provided using a separate policy table and iterative look-ups. In such implementation, what may be used is a first table of the mappings of FIG. 1A (e.g. a mapping database) together with the inclusion of IIDs and a second table which simply indicates the communication policy (e.g. a policy database) in order to provide the system with sufficient information to perform look-ups across the VRFs. Other variations are possible as well.

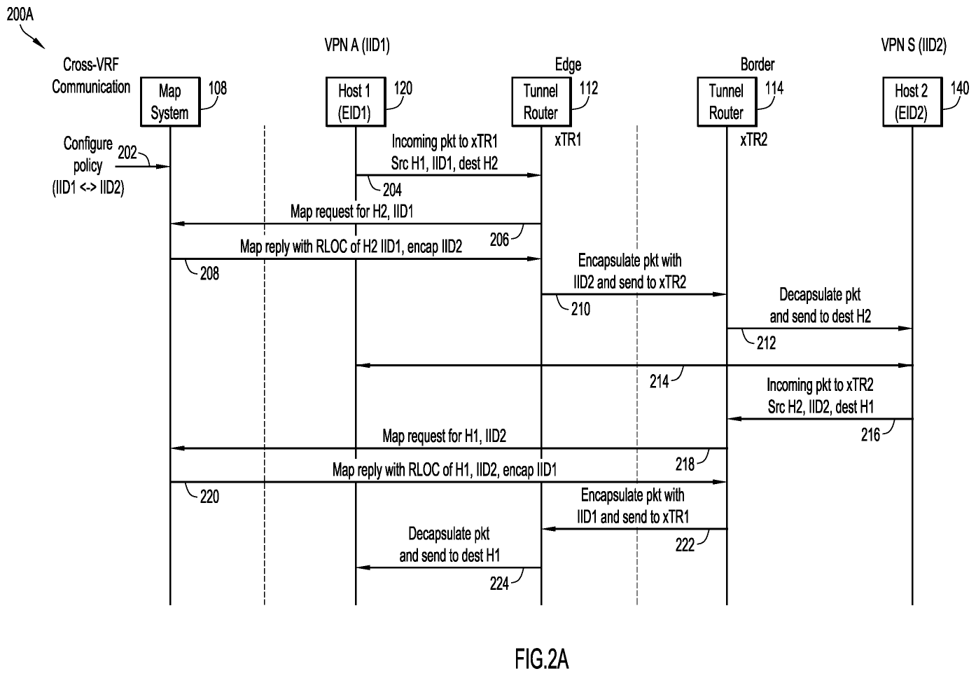

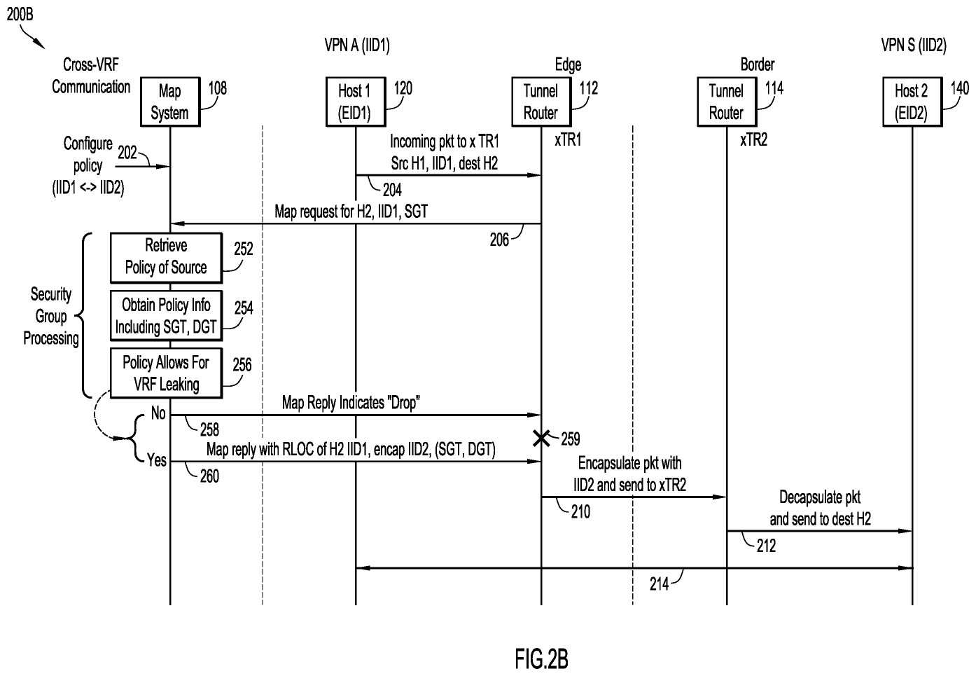

Referring ahead now to FIG. 2A, a message flow diagram 200A for describing a general method of providing route information to routers across VPNs to facilitate extranet VPN communication is now described. The method may involve cross-VRF communication. The method of FIG. 2A may be employed in a network infrastructure arrangement described in relation to FIG. 1A or 1B, with the following simplifications for clarity: host 120 (i.e. Host 1) is a member of VPN A associated with “IID1” and host 140 (i.e. Host 2) is a member of VPN S associated with “IID2” which is a remote extranet VPN; host 120 (i.e. Host 1) may be identified by EID1 and host 140 (i.e. Host 2) may be identified by EID2.

In FIG. 2A, mapping system 108 may receive a message indicating an instruction to configure or update a communication policy in mapping system 108 (step 202 of FIG. 2A). The communication policy may be or be referred to a cross-VRF communication policy. The extranet cross-VRF communication policy may instruct mapping system 108 to facilitate extranet cross-VRF communication between VRF A of VPN A associated with IID1 and VRF S of VPN S associated with IID2. Subsequently, after configuration of the policy, a communication may be initiated by host 120 in VPN A. More specifically, host 120 in VPN A may send to tunnel router 112 a message comprising a data packet intended for host 140 of VPN S (step 204 of FIG. 2A). The data packet may be an IP data packet. The data packet may have a source address corresponding to host 120 in VPN A, a destination address corresponding to host 140 in VPN S, and indicate a context of IID1 of VPN A. Tunnel router 112 may receive the data packet and, in response, send to mapping system 108 a message indicating a map request for requesting a router mapping associated with host 140 (step 206 of FIG. 2A). The map request may include the context of IID1 of VPN A. Mapping system 108 may receive the message indicating the map request and, in response, send to tunnel router 112 a message indicating a map reply (step 208 of FIG. 2A). The map reply may include the address of the tunnel router (e.g. the RLOC) which is mapped to host 140 in VPN S, the context of IID1 of VPN A, and an encapsulated IID2 associated with the VPN S. The RLOC may be the address for tunnel router 116 in the VPN S. Tunnel router 112 may receive the message indicating the map reply and, in response, proceed with the forwarding of the data packet to host 140. Here, tunnel router 112 may encapsulate the earlier-received data packet with IID2 associated with VPN S and send to tunnel router 114 the encapsulated data packet (step 210 of FIG. 2A). Tunnel router 114 may receive the encapsulated data packet and, in response, decapsulate the data packet and send the data packet to host 140 of VPN S (step 212 of FIG. 2A). Host 140 of VPN S may receive and process the data packet. Further communication may then proceed between host 120 of VPN A and host 140 of VPN S (step 214 of FIG. 2A).

Similar processing may be performed for communications initiated by a host (e.g. host 140) in the VPN S. More particularly, host 140 in VPN S may send to tunnel router 114 a message comprising a data packet intended for host 120 of VPN A (step 216 of FIG. 2A). The data packet may be an IP data packet. The data packet may have a source address corresponding to host 140 in VPN S, a destination address corresponding to host 120 in VPN A, and indicate a context of IID2 of VPN S. Tunnel router 114 may receive the data packet and, in response, send to mapping system 108 a message indicating a map request to request a router mapping associated with host 120 (step 218 of FIG. 2A). The map request may include the context of IID2 of VPN S. Mapping system 108 may receive the message which includes the map request and, in response, send to tunnel router 114 a message which includes a map reply (step 220 of FIG. 2A). The map reply may include the address of the router that is mapped to host 120 in VPN A, the context of IID2 of VPN S, and an encapsulated IID1 associated with the VPN A. Tunnel router 114 may receive the message indicating the map reply and, in response, proceed with the forwarding of the data packet to host 120. Here, tunnel router 116 may encapsulate the earlier-received data packet with IID1 associated with VPN A and send to tunnel router 112 the encapsulated data packet (step 222 of FIG. 2A). Tunnel router 112 may receive the encapsulated data packet and, in response, decapsulate the data packet and send the data packet to host 120 of VPN A (step 224 of FIG. 2A). Host 120 of VPN A may receive and process the data packet. Further communication may then proceed between host 120 of VPN A and host 140 of VPN S.

FIG. 2B is a message flow diagram 200B for describing a method for use in a network overlay fabric to provide a secure group-based access to shared services in an external (e.g. extranet) network. In the technique of FIG. 2B, mapping system 108 may be configured to maintain access to communication policies (e.g. an extranet cross-VRF communication policy), at least some of which may be provisioned to include security group tags (SGTs) associated with security groups having host members for access to the shared services via the extranet (e.g. access to host 140 which is a shared server). As with the method of FIG. 2A, the method of FIG. 2B may be employed in a network infrastructure arrangement described in relation to FIG. 1A or 1B, with the following simplifications for clarity. Here again, host 120 (i.e. Host 1) is a member of VPN A associated with “IID1” and host 140 (i.e. Host 2) is a member of VPN S associated with “IID2” which is a remote extranet VPN; host 120 (i.e. Host 1) may be identified by EID1 and host 140 (i.e. Host 2) may be identified by EID2. The method of FIG. 2B may include the same or similar steps 202-206 and 210-214 described in relation to FIG. 2A, and further include group policy processing of steps 252, 254, 256, 258, 259, and 260.

After the configuration of step 202 of FIG. 2B, host 120 in VPN A may send to (edge) tunnel router 112 a message comprising a data packet intended for host 140 of VPN S (step 204 of FIG. 2B). The data packet may have a source address corresponding to host 120 in VPN A, a destination address corresponding to host 140 in VPN S, and indicate a context of IID1 of VPN A. Tunnel router 112 may receive the data packet and, in response, send to mapping system 108 a message which includes a map request to request a router mapping associated with host 140 (step 206 of FIG. 2B). The map request may include the context of IID1 of VPN A, as well as an SGT. Mapping system 108 may receive the message which includes the map request and, in response, identify the IID of the source of host 120 of VPN A (i.e. IID1), and selectively retrieve one of a plurality of communication policies (i.e. an extranet cross-VRF communication policy) associated with the identified source IID (step 252 of FIG. 2B). The retrieval of the appropriate policy may additionally or alternatively be selected based on a source VPN ID (VID) and/or source IP address of host 120 of the VPN A. Mapping system 108 may obtain, from the selected communication policy, policy information which includes an SGT associated with a security group within which host 120 is a member (step 254 of FIG. 2B).

Mapping system 108 may test or identify whether the selected communication policy allows for cross-VRF communication for the security group associated with the SGT (step 256 of FIG. 2B). If as identified in step 356 the policy does not allow or prohibits the cross-VRF communication for the security group, then mapping system 108 may send to tunnel router 112 a message indicating a map reply with an indication to “drop” the data packet (step 258 of FIG. 2B). More specifically, the message in step 258 may be a message indicating a negative map reply (NMR) which may be referred to as an NMR message. Tunnel router 112 may receive this message and, in response, “drop” or refrain from further forwarding the data packet (step 259 of FIG. 2B). If as identified in step 256 the policy does allow the cross-VRF communication for the security group, then mapping system 108 may send to tunnel router 112 a message which includes a map reply (step 260 of FIG. 2B). The map reply in step 260 may include the address of the tunnel router which is mapped to host 140 in VPN S, the context of IID1 of VPN A, a source group tag (SGT), a destination group tag (DGT), and an encapsulated IID2 associated with the VPN S. The tunnel router 112 may receive the message which includes the map reply and, in response, proceed with the forwarding of the data packet only if permitted by the applied policy which is based on the SGT and DGT. If the forwarding is permitted by the applied policy, tunnel router 112 may encapsulate the earlier-received data packet with IID2 associated with VPN S and send to (border) tunnel router 114 the encapsulated data packet (step 210 of FIG. 2B). The tunnel router 114 may receive the encapsulated data packet and, in response, decapsulate the data packet and send the data packet to host 140 of VPN S (step 212 of FIG. 2B). Host 140 of VPN S may receive and process the data packet. Further communication may then proceed between host 120 of VPN A and host 140 of VPN S (step 214 of FIG. 2B).

Referring back now to FIG. 1C, an illustrative representation of a network infrastructure arrangement 100C which is the same as the network infrastructure arrangement 100B of FIG. 1B is shown, but further illustrating that tunnel router 114 (now, “border” tunnel router) may provide external network connectivity to an external network 180 (e.g. the Internet) via a router. External network 180 does not employ the same network overlay protocol (e.g. LISP) used in network overlay fabric 102. To provide external network connectivity, a complex routing protocol such as border gateway protocol (BGP) 190 may be required according to conventional techniques.

FIG. 1D is an illustrative representation of a network infrastructure arrangement 100D which is the same as network infrastructure arrangement 100C of FIG. 1C, but where tunnel router 114 and mapping system 108 may be configured to use a publish-subscribe mechanism 195 to facilitate (at least a semi-) auto-configurable, external network connectivity to external network 180 via the router. Here, the complex routing protocol of FIG. 1C (e.g. BGP 190) need not be utilized.

FIG. 1E is an illustrative representation of functional block diagrams 100E of mapping system 108 and border tunnel router 114 of FIG. 1D, which incorporate the publish-subscribe-based mechanism for the auto-configurable, external network connectivity. More particularly, mapping system 108 of FIG. 1E may include a route providing function 162, a publish-subscribe function 164, and a mapping database access function 168 for access a mapping database (DB) 160. Mapping system 108 may be or include and/or be more generally characterized as a communications management server or entity. Tunnel router 114 of FIG. 1E may include an external provider VRF or provider VRF 172, a route obtaining function 176, and a subscription function 178. Subscription function 178 of tunnel router 114 may operate to subscribe to publications from mapping system 108 via publish-subscribe function 164 (or “publish-subscribe function”), in order to receive from mapping system 108 an initial set of extranet VPN prefixes associated with the network overlays and to regularly receive publications of updates to the extranet VPN prefixes. When received at tunnel router 114, the external VPN prefixes are stored in association with provider VRF 172 as external VPN prefixes 174. Publish-subscribe function 164 may have access to one or more subscriptions lists 166 of (tunnel) routers that have subscribed to publications from mapping system 108. Route obtaining function 176 and route providing function 162 may operate together as described in relation to message flow diagram 200A of FIG. 2A. In general, route obtaining function 176 may operate to, in response to receiving a communication associated with one of stored extranet VPN prefixes 174 of provider VRF 172, send to mapping system 108 a message indicating request for a host-to-router mapping and receive, in response from mapping system 108, a message indicating a reply which includes the host-to-router mapping.

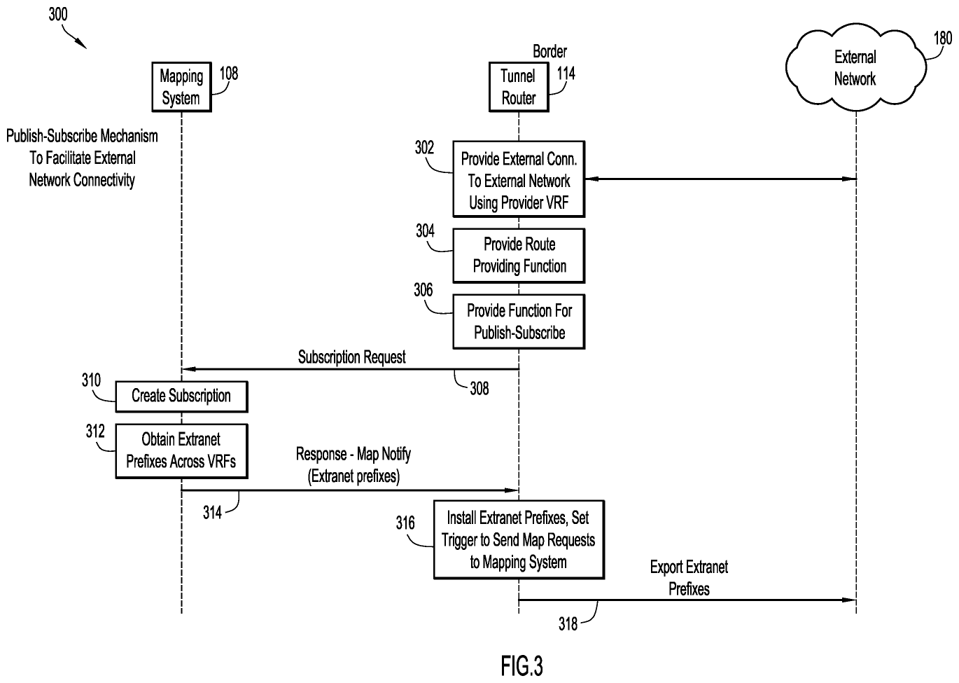

Referring now to FIG. 3, a process flow diagram 300 for describing a publish-subscribe-based method to provide an auto-configurable, external network connectivity is shown. The method may be for use with functional block diagrams 100E of FIG. 1E. Note that, in FIG. 3, border tunnel router 114 is connected to network overlay fabric 102 (FIG. 1D) and to external network 180. However, external network 180 does not employ the same network overlay protocol (e.g. LISP) used in such network overlay fabric 102. Thus, external connectivity may be enabled or facilitated with external network 180 with use of an external provider VRF associated with external network 180 (step 302 of FIG. 3). In FIG. 3, a route obtaining function associated with the provider VRF may also be provided in tunnel router 114 (step 304 of FIG. 3). The route obtaining function may be route obtaining function 176 of FIG. 1D. The route obtaining function may be, for example, the same or similar function as described earlier in relation to FIG. 2A, where map requests and replies are communicated with mapping system 108 to obtain route information (see e.g. route obtaining function 176 of FIG. 1E). A route update subscription function associated with the provider VRF may also be provided in tunnel router 114 (step 306 of FIG. 3). This subscription function may be a function for subscribing to and receiving publications of updates or changes to host-to-router mappings in mapping system 108 (see e.g. subscription function 178 of FIG. 1E). To obtain a subscription, tunnel router 114 may send to mapping system 108 a message indicating a request for a subscription (step 308 of FIG. 3). The subscription request may be a request to receive publications (or “pushes”) of updates or changes to host-to-router mappings in mapping system 108 in response to such updates or changes. The message may include an identifier of the tunnel router and a source IID of the provider VRF. Mapping system 108 may receive the subscription request and, in response, may create a subscription associated with the identifier of tunnel router 114 (step 310 of FIG. 3). Here, mapping system 108 may add the identifier of tunnel router 114 to a list such as a subscription list. Here, mapping system 108 may look up and/or obtain a plurality of extranet prefixes across a plurality of (e.g. all) VRFs (step 312 of FIG. 3). The extranet prefixes may be obtained based on the source IID in the message. Mapping system 108 may then send to tunnel router 114 a message indicating a response to the subscription request (step 314 of FIG. 3). The response may include the extranet prefixes across the VRFs. These extranet prefixes may be summary extranet prefixes. In other implementations, the extranet prefix may be or include non-summary prefixes. Tunnel router 114 may receive the response and install the extranet prefixes in association with the provider VRF (step 316 of FIG. 3). The extranet prefixes may be installed in association with an action(s) or trigger(s) to send a message indicating a map request to mapping system 108, with use of the route obtaining function. Finally, border tunnel router 114 may export the extranet prefixes to external network 180 for installation (step 318 of FIG. 3).

As described earlier above in the Background section, service insertion poses challenges in enterprise private networks when multiple services need to be applied in relation to a particular traffic flow. Services may include firewall or security services, billing or accounting services, service level agreement (SLA) monitoring services, Quality of Service (QoS) policy services, and the like. These challenges become more prevalent in relation to enterprise SDA or SDN fabrics, which are overlay-based and utilize group-based policy and segmentation. Service insertion in enterprise SDA/SDN fabrics is problematic due to the use of traditional service routers that would need to apply the services. Specifically, traditional service routers do not readily support the appropriate encapsulation and tagging (e.g. security group tags or “SGTs”) associated with overlay headers of data packets for appropriate processing. Traditionally, access control list (ACL)/policies (e.g. for policy-based routing) are used on an edge or border router to redirect traffic to service routers. However, this approach does not scale well as the number of flows, groups, and/or subnets become larger, especially in relation to security services where the traffic needs to be routed to a particular service router (e.g. a firewall). In addition, ACLs consume a great deal of hardware or forwarding resources which may already be scarce, for example, on relatively low-end switches or routers. In a solution, fabric routers that connect to services should be able to differentiate between pre-service and post-service traffic, so that traffic does not get routed back to apply same service again (e.g. looping) after post-service processing. As some services may fail, dynamic service updating is also a feature to consider, and such updating should be transparent to users as the system moves traffic from old to new service instances. Load-balancing to service instances (e.g. hash-based load balancing) should also be achievable in such a solution.

What are described herein are techniques and mechanisms for dynamic group-based service insertion for enterprise private networks for traffic flows using the LISP control plane (e.g. the MS/MR). The techniques and mechanisms of the present disclosure may be built upon or based on traditional techniques and mechanisms described in relation to LISP, for example, in relation to FIGS. 1A-1B, 1D-1E, 2A-2B, and 3. As an illustrative example, a first tunnel router may trigger a Map-Request to an MS/MR which responds with a Map-Reply which normally includes an RLOC of a second tunnel router (e.g. xTR), to populate the first tunnel router with the overlay route for communication. For example, the MS/MR may provide an EID-to-RLOC mapping in the Map-Reply. On the other hand, the Map-Reply may alternatively include service insertion information for a service border router (e.g. an xTR, and/or a service-id) according to a source group tag and/or a destination group tag, so that the populated overlay route may include the service insertion information for insertion of the service.

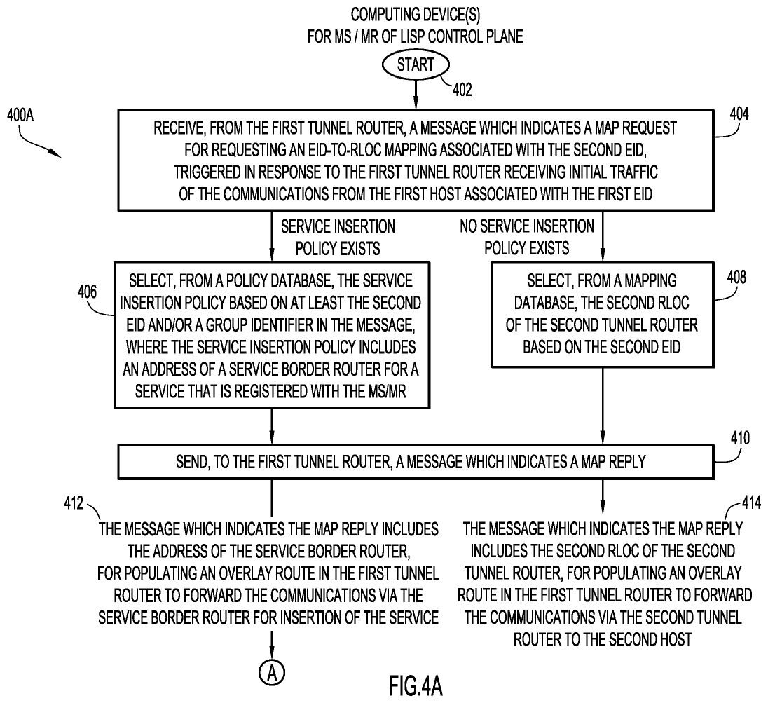

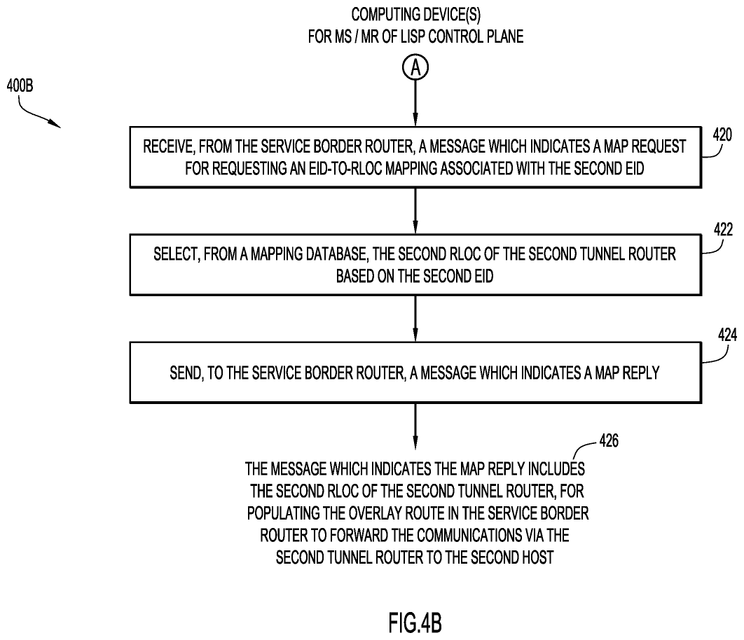

FIG. 4A is a flowchart 400A for describing a method for a group-based service insertion using an MS/MR of a LISP control plane in enterprise private networks according to some implementations of the present disclosure. The method of FIG. 4A may be performed by a computing device or a network node configured to connect in a network for communication. In some implementations, the computing device or network node may include at least one or more interfaces configured to connect to a network for communication (e.g. for SDA or SDN), one or more processors, one or more memory elements coupled to the one or more processors, and instructions stored in the one or more memory elements for operating as the MS/MR of the LISP control plane. In some preferred implementations, the computing device(s) may implement the MS/MR of the LISP control plane as well as tunnel router functionality on the same device (with logical separation of the functionality). The method may be embodied as a computer program product including a non-transitory computer readable medium (e.g. one or more memory elements) and instructions stored in the computer readable medium, where the instructions are executable on one or more processors for performing the steps of the method. In some implementations, the instructions stored in the one or more memory elements may be executable on the one or more processors for operation as the MS/MR of the LISP control plane.

In the method of FIG. 4A, the computing device which implements the MS/MR of the LISP control plane may be configured to facilitate communications from a first host that is located for communication via a first tunnel router to a second host that is located for communication via a second tunnel router. The first and the second hosts are assigned with first and second EIDs, respectively, and the first and the second tunnel routers are assigned with first and second RLOCs, respectively. A service border router may be connected to a service node or a service router having one or more services (e.g. a firewall service). Prior to use of a service, the MS/MR may receive, from the service border router, a message which indicates a service registration for registering the service with the MS/MR.

Beginning at a start block 402 of FIG. 4A, the MS/MR may receive, from the first tunnel router, a message which indicates a map request for requesting an EID-to-RLOC mapping associated with the second EID (step 404 of FIG. 4A). The map request is triggered in response to the first tunnel router receiving initial traffic of the communications from the first host. When a service insertion policy for the communications exists, the MS/MR may select, from a policy database, the service insertion policy based on at least the second EID and/or a group identifier in the message (step 406 of FIG. 4A). The service insertion policy may include an address of a service border router for a service that is registered with the MS/MR. The service may be one of firewall or security service, a billing or an accounting service, an SLA monitoring service, or a QoS policy service, as a few examples. The MS/MR may send, to the first tunnel router, a message which indicates a map reply (step 410 of FIG. 4A). The message which indicates the map reply may include the address of the service border router, for populating an overlay route in the first tunnel router to forward the communications via the service border router for insertion of the service (step 412 of FIG. 4A).

On the other hand, when no service insertion policy exists, the MS/MR may select, from a mapping database, the second RLOC of the second tunnel router based on the second EID (step 408 of FIG. 4A). Again, the MS/MR may send, to the first tunnel router, the message which indicates the map reply (step 410 of FIG. 4A). The message which indicates the map reply may include the second RLOC of the second tunnel router, for populating the overlay route in the first tunnel router to forward the communications via the second tunnel router to the second host (step 414 of FIG. 4A).

As mentioned above, prior to receiving the initial traffic of the communications from the first host, the computing device may receive, from the service border router, a message which indicates a service registration for registering the service with the MS/MR. In some implementations, service registration is performed by each one of a plurality of services available via the service border router(s). Here, the selecting of the service insertion policy may involve selecting the service insertion policy from a plurality of service insertion policies respectively associated with the plurality of services registered with the MS/MR. In some implementations, the selecting of the service insertion policy from the plurality of service insertion policies may be performed according to a service ID associated with the service insertion policy or service.

In some implementations of step 406, 410, and 412, the group identifier may be an SGT, and the service insertion policy may be selected based on at least the SGT and a DGT associated with the second host. Here, in step 410, the computing device may send, to the first tunnel router, the message which indicates the map reply and includes the address of the service border router, to further include the SGT, the DGT, and a group policy for application at the first tunnel router. In one example, the group policy comprises a group policy for access or access control.

In some implementations of steps 406, 410, and 412, the service insertion policy further includes an instance ID associated with a VRF at the service border router. Here, the message which indicates the map reply may include the address of the service border router, a virtual network identifier of a virtual private network associated with the VRF, and the group identifier, for populating the overlay route in the first tunnel router to forward the communications, with encapsulation of the virtual network identifier and the group identifier, via the service border router for insertion of the service. Here, the service border router may perform decapsulation and then forward the communications to a service node/router (e.g. a firewall or firewall service) via the VRF using L3 communications (e.g. tunnel encapsulation); the communications may return to the service border router in a similar manner after processing.

In other implementations of steps 406, 410, and 412, the service insertion policy further includes a VLAN ID of a VLAN. Here, the message which indicates the map reply may include the address of the service border router, the VLAN ID, and the group identifier, for populating the overlay route in the first tunnel router to forward the communications, with encapsulation of the VLAN ID and the group identifier, via the service border router for insertion of the service. Here, the service border router may perform decapsulation and then forward the communications to the service node/router (e.g. the firewall or firewall service) via the VLAN using L2 communications (e.g. tunnel encapsulation); the communications may return to the service border router in a similar manner after processing.

The method of FIG. 4A may continue on through a connector A to a flowchart 400B of FIG. 4B. From connector A of FIG. 4B, the MS/MR may receive, from the service border router, a message which indicates a map request (i.e. another map request) for requesting an EID-to-RLOC mapping associated with the second EID (step 420 of FIG. 4B). The MS/MR may select, from the mapping database, the second RLOC of the second tunnel router based on the second EID (step 422 of FIG. 4B). The MS/MR may send, to the service border router, a message which indicates a map reply and includes the second RLOC of the second tunnel router (step 424 of FIG. 4B). The message which indicates the map reply and includes the second RLOC of the second tunnel router is for populating an overlay route in the service border router to forward the communications via the second tunnel router to the second host (step 426 of FIG. 4B).

As is apparent, in some implementations, the MS/MR may be operative to select either the service insertion policy (see e.g. step 406 of FIG. 4A) or the second RLOC of the second tunnel router (see e.g. step 422 of FIG. 4B) based on identifying an indication (e.g. a message indication) of whether the message which indicates the map request or the other map request is sent from the first tunnel router (as in step 406 of FIG. 4A) or the service border router (as in step 422 of FIG. 4B).

Again, as described above in relation to FIGS. 4A and 4B, service registration with the MS/MR may be performed by each one of a plurality of services that are available via the service border router(s). When a service (or its associated path) becomes unavailable or is taken off-line, the service border router may send a message for service deregistration of the service. When the service (or its associated path) becomes available again or is brought back online, the service border router may again send a message for service registration for registration of the service. When a new or updated service becomes available, the service border router may send a message for service registration for registration of the new or updated service. As is apparent, the MS/MR may be updated dynamically for indicating the availability or non-availability of services. Further, a plurality of service routers/service instances associated with a (e.g. single) service may register/deregister for load balancing and/or redundancy for the service.

In some implementations, when the second host is a 5G endpoint which is located for communication via the second tunnel router that is external to the enterprise private network, the MS/MR may receive, from the service border router, a message which indicates a map request for requesting an EID-to-RLOC mapping associated with the second EID. The MS/MR may then send, to the service border router, a message which indicates a second map reply and includes a third RLOC of a border router. The message which indicates the second map reply and includes the third RLOC of the border router is for populating an overlay route in the border router to the second host via the second tunnel router that is external to the enterprise private network.

Two detailed scenarios for service insertion using the MS/MR of the LISP control plane (or “service control plane”) will now be described, Scenario (A) and Scenario (B). Although a firewall service is used as an example in the scenarios, any suitable service at a service node or a service router may be employed. The service may be one of firewall or security service, a billing or an accounting service, an SLA monitoring service, or a QoS policy service, as a few examples. In the discussion, the service border router may be referred to simply as a service border (SB).

In Scenario (A), service insertion using LISP MS/MR may be characterized as “within” virtual network (VN)/VRF service insertion. For the same VN/VRF service insertion, the approach is to use LISP service registration from a service border with service insertion policies (e.g. based on groups, application ID, port number etc.). Since the service control plane is requested to provide a mapping of the destination with the destination switch (i.e. the RLOC), policy for a source-destination pair may be easily, selectively applied at the forwarding switch. This may be done without the need to download all policies (*, *) on the forwarding switches, thereby saving forwarding resources.

In some implementations, each VN/VRF may perform a different service registration (with different RLOCs and service policy) at the service border connected to the service, for any and all services to be applied. After traffic is communicated to the service border for the service, the service border may return the traffic to another VN/VRF where the destination host would be reachable. Here, no service would be applied again. Rather, the traffic may be sent to the final destination which is within the enterprise private network or outside to the Internet/5G network. The same mechanism may be used for return traffic from the Internet/5G network to enterprise hosts when the destination path is requested from the service control plane (e.g. LISP MS/MR, using Map-Request or LISP PUB-SUB).

In some implementations, the high-level flow may be as follows:

1. The service border may perform a service registration to the MS/MR with all policy/parameters required for service insertion in its own VRF.

2. The MS/MR may store the information, for example, in a separate policy database (e.g. outside of the standard registration/mapping database).

3. When the edge boots up, it may query the MS/MR for edge policies (e.g. per security group, subnet, or VN/VRF) and the default-service-etr. The MS/MR may reply with the registered service border, or a configured first-packet-service-border within the same VRF.

4. The Map-Request may be differentiated, and inserted with a service indication (and service-id, source security group identifier, etc.) based on whether it is an original, pre-service Map-Request or a post-service Map-Request. This may be determined based on whether the Map-Request originator node is the edge or the service border that performed the service registration (and has the local path to the service router).

5. Based on the indication (and the service-id, SGT) in the Map-Request, the MS/MR may reply with the appropriate RLOC (i.e. of the service border or the final destination) and any destination parameters needed (e.g. the destination security group, destination VN/VRF) after applying the destination policies (e.g. the SGACL based on the SGT, DGT).

6. If the destination policy does not allow the communication (e.g. the SGT, DGT pair is denied), the MS/MR does not reply with a positive Map-Reply (or it may send a Negative Map Reply or “NMR”), which may possibly facilitate the dropping of the packet at the source node itself instead of the destination node.

In Scenario (B), service insertion using LISP MS/MR may be characterized as “across” VRF service insertion. For across VRF service insertion, the above-described approach is extended to use the LISP extranet with subscriber-to-subscriber communication and service insertion policies (e.g. for groups, application ID, port number, etc.). After the traffic traverses the service border (e.g. the firewall), the service may return the traffic to another subscriber VN/VRF, where the destination host would be reachable and no service would be applied again, sending traffic flow to the final destination within the enterprise private network or outside to the Internet/5G network.

In some implementations, the high-level flow may be as follows:

1. The service border may perform a service registration with the MS/MR with all policy/parameters for the service insertion in its own VRF.

2. The MS/MR may be provisioned with across VN/VRF/VLAN policies which include service insertion policies.

3. When the edge boots up, it may query the MS/MR for the edge policies (e.g. per security group, subnet, or VN/VRF) and the default-service-etr. The MS/MR may reply with the registered service border or a configured first-packet-service-border within the same VRF.

4. The MS/MR may store the information, for example, in a separate policy database (e.g. outside the standard registration/mapping database).

5. The Map-Request may be differentiated, and inserted with the service indication (and the service-id, source security group, etc.) based on whether it is the original pre-service Map-Request or a post-service Map-Request. This may be determined based on whether the Map-Request originator node is the edge or the service border that performed the service registration (and has the local path to the service router).

6. Based on the Map-Request indication, the MS/MR may check whether the destination is reachable within the same VRF (e.g. Scenario A) or across VRF. For across VRF destinations, it may additionally check the extranet and extranet service insertion policy. It may proceed further (e.g. only) if the extranet policy allows for it.

7. Based on the indication (and the service-id, SGT) in the Map-Request, the MS/MR may reply with appropriate RLOC (i.e. the service border or the final destination) and any destination parameters needed (e.g. destination security group, destination VN/VRF) after applying the destination policies (e.g. the SGACL based on SGT, DGT).

8. If the destination policy does not allow the communication (e.g. the SGT, DGT pair is denied), the MS/MR does not reply with a positive Map-Reply (or it may send an NMR), which may possibly facilitate the dropping of the packet at the source node itself instead of the destination node.

Advantageously, the techniques and mechanisms of the present disclosure may be employed both for fabric-deployments as well as non-fabric (traditional) deployments.

Below is an example configuration for service insertion using the service control plane, for allowing dynamic SGT-based service insertion for both SDA and non-SDA deployments.

Example Configuration:

Border:
=====
instance-id 3 (In Provider VRF/IID)
database-mapping <default-route-prefix/mask-length> locator-set set1
default-etr /* Internet */
!
instance-id 1 & 2 (In subscriber VRF/IID)
database-mapping <service-EID> 2 [service-insertion <service-id> 2
<firewall>] [sgt <100> dgt<200>] locator-set set1 service-etr
/* Service-EID = Service Prefix to watch */
!
Service Control Plane (aka MSMR):
================
extranet ext1
eid-record-provider instance-id 3
30.0.0.0/8
ip-any
!
eid-record-subscriber instance-id 1
100.1.1.0/24
ip-any
sgt <1-100>
service-insertion <service-id> {firewall} instance 2
[<prefix>]
sgt <100> dgt <200>
!
eid-record-subscriber instance-id 2
200.1.1.0/24
ip-any
sgt <101-200>
service-insertion <service-id> {firewall} instance 1
[<prefix> ]
sgt <200> dgt <100>
!

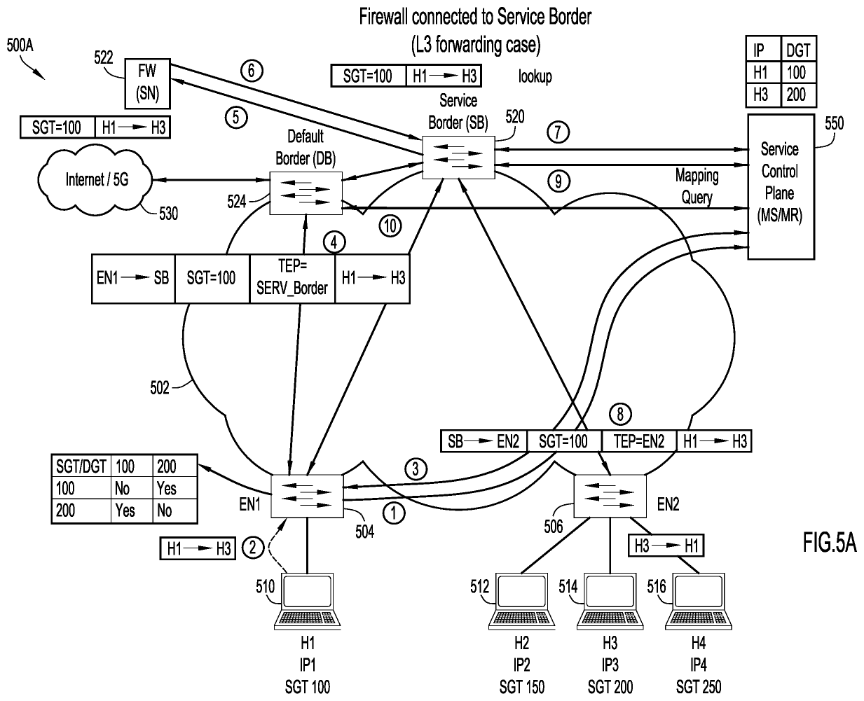

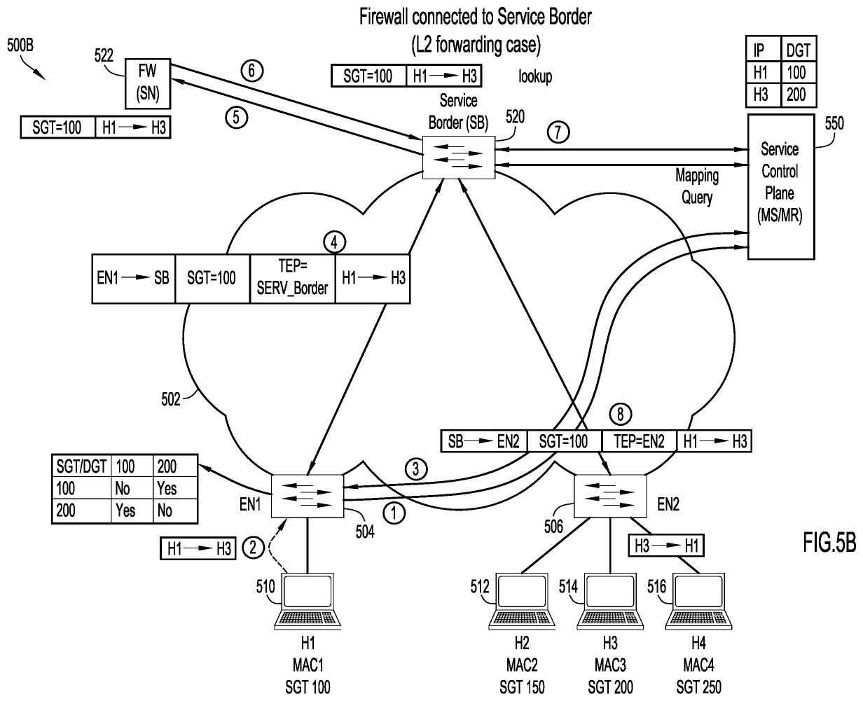

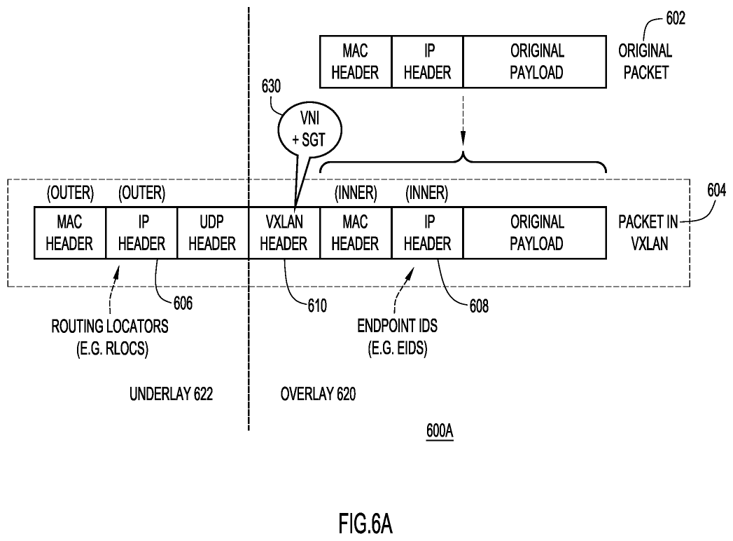

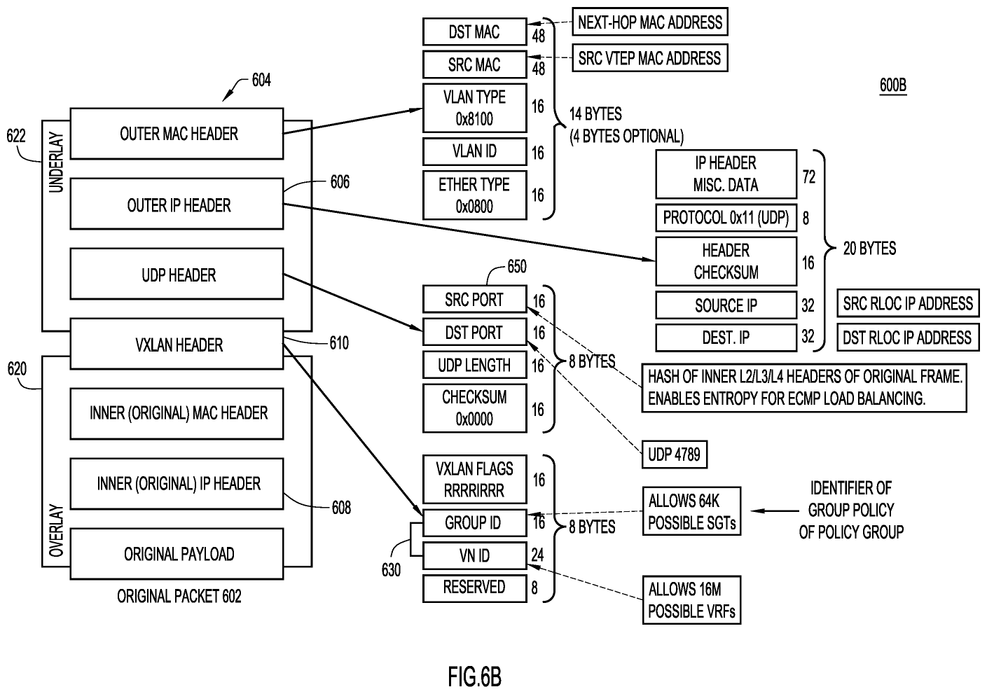

As now described in relation to FIGS. 5A and 5B, group-based service insertion for virtual enterprise private networking may be facilitated, with use of L2 or L3 forwarding, using the LISP control plane. Again, the techniques and mechanisms of the present disclosure may be built upon or based on traditional LISP techniques and mechanisms, for example, those described in relation to FIGS. 1A-1B, 1D-1E, 2A-2B, and 3. The techniques and mechanisms of the present disclosure in FIGS. 5A and 5B may make use of the example message formats for packet encapsulation and overlay routing, discussed later in relation to FIGS. 6A-6B.

FIG. 5A is a network architecture 500A with message flow for facilitating a group-based service insertion, with L3 forwarding, using the LISP control plane according to some implementations of the present disclosure. Network architecture 500A of FIG. 5A includes a network fabric 502, a tunnel endpoint 504 (“EN1”), and a tunnel endpoint 506 (“EN2”). Tunnel endpoints 504 and 506 (or tunnel routers) may be referred to as edge nodes, edge devices, or edges. A service border (SB) 520 may connect to a service node (SN) 522 (or service router) having a service (e.g. a firewall service or “FW”). In some implementations, a plurality of services may be available via SB 520, and these services may be identified by different service IDs. A default border (DB) 524 may interconnect with an Internet/5G network 530, as well as to SB 520. A host 510 (“H1”), which is located at tunnel endpoint 504 (“EN1”), may be assigned with an IP address of “IP1” and an SGT of 100. Hosts 512, 514, and 516 (“H2,” “H3,” and “H4,” respectively) are located at tunnel endpoint 506 (“EN2”). Host 512 (“H2”) may be assigned with an IP address of “IP2” and an SGT of 150; host 514 (“H3”) may be assigned with an IP address of “IP3” and an SGT of 200; and host 516 (“H4”) may be assigned with an IP address of “IP4” and an SGT of 250.

The LISP control plane may include an MS/MR 550 which serves as a service control plane for dynamic service insertion. A high-level flow for the dynamic service insertion using L3 forwarding is now described. Initially, SB 520 may perform registration from an L3 instance (i.e. VRF) with its IP address and policy (e.g. SGT-DGT, etc.).

1. When tunnel router 510 boots up, MS/MR 550 may invoke tunnel router 510 (EN1) to install a default service insertion policy, specifying that traffic for 0/0 (or a specific subnet/group) is to be sent to a specific/default SB to apply a service (e.g. a firewall service). This may be considered a first packet punt and forward policy. One of at least two options may be utilized:

(a) Redirect unresolved traffic at tunnel endpoint 504 (EN1) to an appropriate SB; or

(b) Redirect unresolved traffic to a first packet forwarder (e.g. pre-populated via PUB-SUB).

2. In general, traffic is intended to be communicated from host 510 (H1) at IP1 to host 514 (H3) at IP3.

3. Tunnel router 504 (EN1) may send a Map-Request to resolve for H3 (in SGT 100 context) with MS/MR 550, which will return the SB 520 (e.g. SB, VRF) and also return the DGT 200 corresponding to H3 per the service insertion policy. Two options may be utilized here:

(a) The policy may be applied at tunnel endpoint 504 (EN1). Here, the forwarding plane may trigger a Map-Request for the destination in the VRF context, carrying the SGT, but the policy may be applied at the edge. MS/MR 550 may reply based on the destination and VRF, but with the DGT and the policy for the SGT-DGT. The forwarding plane on the edge may install the policy for the SGT-DGT, in addition to the forwarding entry (e.g. in the map-cache). In this case, the forwarding plane may operate to regenerate the Map-Request on a “miss” when the corresponding SGT-DGT policy is not available at the forwarding plane.

(b) The policy may be applied at MS/MR 550. Here, the forwarding plane on the edge may trigger resolution (i.e. a Map-Request) in the SGT 100 context for the destination H3. The service control plane may reply after applying the policy with the appropriate node (e.g. SB 520, or DB 524 or destination edge node). Here, the forwarding plane may (simply) install the forwarding entry at the edge (i.e. no SGT, DGT policy at the edge). This option assumes that the forwarding plane is configured to generate a Map-Request in the SGT 100 context for the destination.

While generating the Map-Request, the edge may also forward the packet to the default SB. The policy may provide the firewall IP or the SB IP (e.g. based on which entity performed the service insertion registration). A separate SB would not be required in the case where the firewall can directly terminate the VxLAN. The Map-Reply may also indicate “native-forward.”

4. The tagged packet may be sent to SB 520 with the VxLAN Network Identifier (VNI) and SGT encapsulation.

5. The SB 520 may decapsulate the traffic and send the traffic to SN 522 (i.e. the firewall) using L3/VRF. The SB IP as Tunnel Endpoint (TEP) in packet encapsulation may be used to identify the traffic that needs to be sent to the firewall. This may be useful in scenarios where SB 520 also serves as a gateway to north-south traffic.

6. SN 522 (i.e. the firewall) may process the traffic and send it back to SB 520 using L3.

7. Since the packet encapsulation TEP is not the IP/RLOC of SB 520 in the service overlay (e.g. or check F bit=0?), SB 520 may perform a map cache query (e.g. or use LISP PUB-SUB) for H3's IP address which will return tunnel endpoint 506 (EN2). MS/MR 550 may determine based on the source of the Map-Request which node to resolve for (e.g. SB 520 or tunnel endpoint 506 (EN2); the request from the SB/VRF will not resolve to same SB/VRF).

8. SB 520 may send the encapsulated packet to tunnel endpoint 506 (EN2).

9. Internet traffic (e.g. associated with NMR) may be sent to DB 524 or SB 520 through VxLAN encapsulation, as mapping resolution for Internet prefixes may point to the DB or SB IP.

10. Return the Internet traffic at DB 524 that has overlay subnets provisioned to generate a Map-Request (or have the mapping pre-installed via LISP PUB-SUB). MS/MR 550 may reply with the mapping resolved to SB 520 or the tunnel endpoint in order to send the return traffic to the service or directly to the destination edge node (e.g. encapsulate with the SB or tunnel endpoint).

FIG. 5B is a network architecture 500B with message flow for facilitating a group-based service insertion, with L2 forwarding, using the LISP control plane according to some implementations of the present disclosure. Here, in contrast with FIG. 5A, host 510 (“H1”) that is located at tunnel endpoint 504 (“EN1”) may be assigned with a media access control (MAC) address of “MAC1” and the SGT of 100. Host 512 (“H2”) may be assigned with a MAC address of “MAC2” and the SGT of 150; host 514 (“H3”) may be assigned with a MAC address of “MAC3” and the SGT of 200; and host 516 (“H4”) may be assigned with a MAC address of “MAC4” and the SGT of 250.

Initially, SB 520 may register with MS/MR 550 with its IP address and group-based service insertion policy within the VLAN or L2 instance-id (e.g. extending the service insertion registration/border convergence mechanism for the L2 instance). An L2 Map-Reply may return the address of SB 520 instead of the normal RLOC. An L2 negative-Map-Reply or NMR may be returned or indicate “forward-native” instead of “drop.” With respect to SB 520 (e.g. if the Map-Request source is the same as the SB), MS/MR 550 may return the normal RLOC. In some implementations, flooding over the tunnel is controlled from the service control plane; local VLAN flooding control may be handled outside of the service control plane. The service control plane may provision the group-based service insertion policy across the VLANs (e.g. extending the extranet service insertion mechanism across L2 instances).

A high-level flow for the dynamic service insertion using L2 forwarding is now described in relation to FIG. 5B. Initially, SB 520 may perform registration from an L2 instance (VLAN) with its IP address and policy (e.g. SGT-DGT, etc.).

1. When tunnel endpoint 504 (EN1) boots up, MS/MR 550 may install a default service insertion policy, such that traffic for any MAC address destination to be sent to a specific SB (or default SB) to apply a firewall service. This is a first packet punt and forward policy for L2. One of at least two options may be utilized:

(a) Unresolved traffic at tunnel endpoint 504 (EN1) may be redirected to an appropriate SB.

(b) Unresolved traffic may be redirected to a first packet forwarder (e.g. a default-service border) which has all static or already-known steering policies (e.g. pre-populated via LISP PUB-SUB).

2. In general, traffic is intended to be communicated from host 510 (H1) at MAC1 to host 514 (H3) at MAC3.

3. Tunnel endpoint 504 may send a Map-Request to resolve for host 514 (H3) (in SGT 100 context) with MS/MR 550, which will return both SB 520 (e.g. SB, VLAN) and also return the DGT 200 corresponding to host 514 (H3) as per the service insertion policy. Two options may be utilized here:

(a) Policy may be applied at tunnel endpoint 504 (EN1). The forwarding plane may trigger a Map-Request for the destination MAC in the VLAN context, carrying the SGT, but the policy may applied at tunnel endpoint 504 (EN1). MS/MR 550 may reply based on the destination and the VLAN, but with the DGT and the policy for the SGT-DGT. The forwarding plane at tunnel endpoint 504 (EN1) may install the policy for the SGT-DGT in addition to the forwarding entry (e.g. in the map-cache). Note that, in this case, the forwarding plane may regenerate the Map-Request on a “miss” when the corresponding SGT-DGT policy is not available at the forwarding plane.

(b) Policy may be applied at MS/MR 550. The forwarding plane at tunnel endpoint 504 (EN1) may trigger a resolution (e.g. a Map-Request) in the SGT 100 context for the destination MAC H3. MS/MR 550 may reply after applying the policy with the appropriate node (SB 520, DB 524, or the destination edge node). The forwarding plane may just install the forwarding entry at the edge (i.e. no SGT-DGT policy at the edge). This option assumes that the forwarding plane is able to generate a Map-Request in the SGT 100 context for the destination MAC.

While generating the Map-Request, tunnel endpoint 504 (EN1) may also forward the packet to DB 524. The policy may provide the firewall IP or the SB IP (e.g. based on which entity performs the service insertion registration in the VLAN). A separate SB would not be necessary in the case the firewall can directly terminate the VxLAN.

4. The tagged packet may be sent to SB 520 with the VNI and SGT encapsulation.

5. SB 520 may decapsulate the traffic and send the traffic to SN 522 (e.g the firewall) using the VLAN. The SB IP as TEP in packet encapsulation may be used to identify the traffic that needs to be sent to the firewall. This may be useful in scenarios where SB 520 also serves as a gateway to north-south traffic.

6. SN 522 may process the traffic and send it back to SB 520 using the VLAN.

7. Since packet encapsulation TEP is not the IP/RLOC of SB 520 in the service overlay (e.g. or check F bit=0?), SB 520 may perform a map cache query (e.g. or use LISP PUB-SUB) for H3 MAC which will return tunnel endpoint 506 (EN2). MS/MR 550 may determine, based on the source of the Map-Request, which node to resolve (i.e. SB 520 or tunnel endpoint 506 (EN2); the request from the SB/VRF will not resolve to same SB/VLAN/VNI).

8. SB 520 may send the encapsulated packet to tunnel endpoint 506 (EN2).

To better illustrate message formatting that may be utilized, with reference to FIGS. 6A-6B, what are shown are example message formats 600A, 600B for packet encapsulation and overlay routing. The formatting provides for an overlay 620 as illustrated. An original packet 602 may include at least an (inner) IP header 608 and an original payload. The (inner) IP header 608 may include source and destination IP addresses of the endpoints (e.g. EIDs) (e.g. hosts). A VXLAN header 610 may be applied to original packet 602. As indicated, VXLAN header 610 may include at least a VNI of the VXLAN and the SGT of the group (see metadata 630). The formatting also provides for an underlay 622 as illustrated. For encapsulation and tunneling, an (outer) IP header 606 may be applied to form an encapsulated packet 604. The outer IP header 606 may include source and destination IP address of the routing locators (e.g. RLOCs).

Advantageously, techniques and mechanisms of the present disclosure may be suitable for use in facilitating virtual enterprise networking with remote access and 5G traffic flows. With the promise of 5G connectivity to provide high-speed direct communication via a shared 5G backbone network, specific services may be inserted in relation to 5G traffic flows that enter into or exit from the network. Advantageously, leveraging LISP and the MS/MR for service insertion as described may be applied for use with remote 5G endpoints or hosts, where a border router which interfaces to the external network or Internet may trigger, based on configured prefixes, the Map-Request/Map-Reply in the same or similar manner for service insertion.

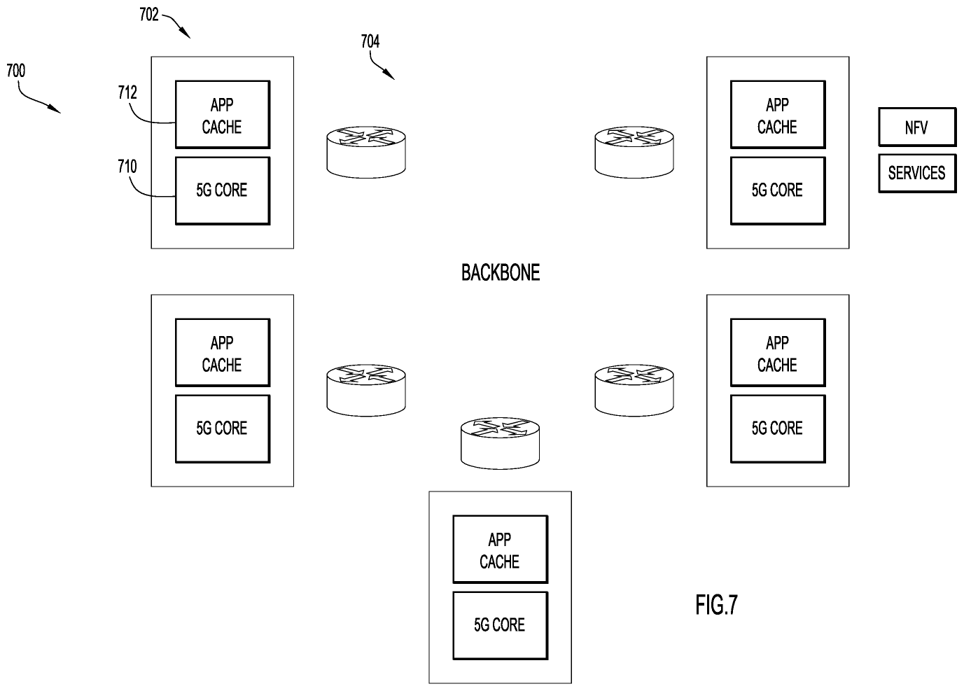

With reference to FIG. 7, a network architecture 700 which includes a shared 5G backbone including a plurality of network routers 704 that may interconnect a plurality of 5G mobile core networks 702, where each 5G mobile core network may include a 5G core 710 and an application cache 712. Here, solving the problem in the general way for enterprise SDA/SDN networks inherently provides the solution for 5G networks. Thus, according to some implementations, service insertion is not bound by topological restrictions. Consider, for example, the current working environment where in-person meetings are restricted (e.g. COVID-19 restrictions) and employees are working remotely. The techniques and mechanisms of the present disclosure allows for dynamic service insertion, making the network truly location-independent (e.g. without the need to bring employee traffic back into the enterprise private network).

Advantageously, service insertion in enterprise SDA/SDN fabrics is simplified and no longer problematic using traditional service routers. The services that may be employed include firewall or security services, billing or accounting services, SLA monitoring services, QoS policy services, and the like. The techniques and mechanisms of the present disclosure are scalable as the number of flows, groups, and/or subnets become larger, and do not require additional consumption of hardware resources. Further, fabric routers that connect to the services are able to differentiate between pre-service and post-service traffic, so that traffic does not get routed back to apply the same service again (e.g. looping) after post-service processing. As some services may fail, dynamic service updating is also feasible, and such updating may be made transparent to users as the system moves traffic from old to new service instances. Even further, the proposed techniques and mechanisms that allow for dynamic service insertion may make the network truly location-independent. At least in some implementations, solving the problem for enterprise SDA/SDN networks according to the present disclosure inherently provide a solution for remote hosts with 5G traffic flows.

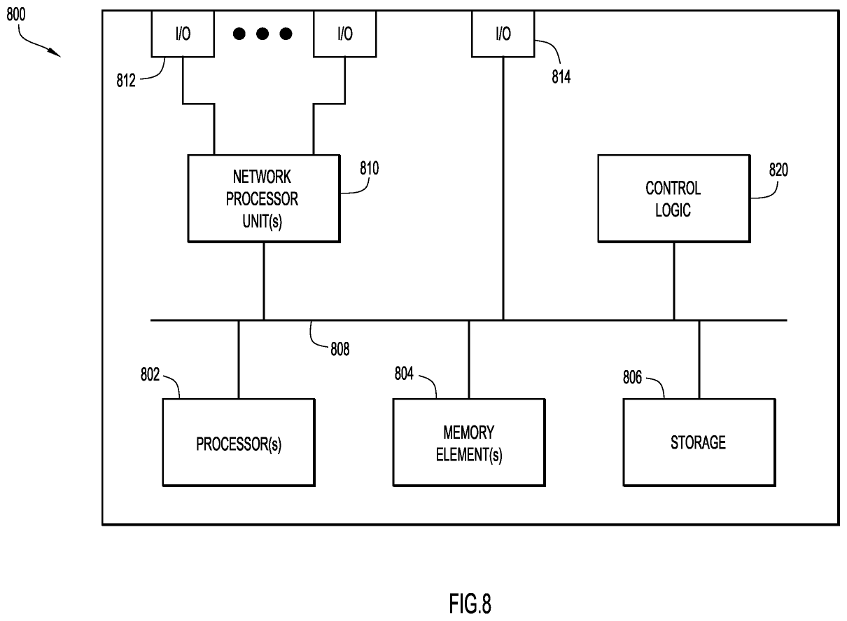

FIG. 8 illustrates a hardware block diagram of a computing device 800 that may perform functions associated with operations discussed herein in connection with the techniques described in relation to the above figures, especially in relation to FIGS. 4A-4B, 5A-5B, and 6. In various embodiments, a computing device, such as computing device 800 or any combination of computing devices 800, may be configured as any entity/entities as discussed for the techniques depicted in connection with the figures in order to perform operations of the various techniques discussed herein.

In at least one embodiment, computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, and/or any other I/O port(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computer device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Thus, techniques and mechanisms for “dynamic” group-based service insertion for enterprise private networks for traffic flows using the LISP control plane or the MS/MR have been described. Such techniques and mechanisms may be suitable for use in facilitating virtual enterprise networking with remote access with 5G traffic flows. The dynamic group-based service insertion (e.g. SGT-based service insertion) may be utilized in both SDA and non-SDA deployments. Note that the techniques and mechanisms of the present disclosure may be applied using other suitable overly technologies, such as BGP-EVPN.

In one illustrative example, a method of the present disclosure may be performed by one or more computing devices (a “computing device”) which implement a MS/MR of a LISP control plane for group-based service insertion in an enterprise private network. The computing device may be configured to facilitate communications from a first host that is located for communication via a first tunnel router to a second host that is located for communication via a second tunnel router. The first and the second hosts are assigned with first and second EIDs, respectively, and the first and the second tunnel routers are assigned with first and second RLOCs, respectively.

In the method, the computing device may receive, from the first tunnel router, a message which indicates a map request for requesting an EID-to-RLOC mapping associated with the second EID, which is triggered in response to the first tunnel router receiving initial traffic of the communications from the first host. When a service insertion policy exists, the computing device may select, from a policy database, a service insertion policy based on at least the second EID or a group identifier in the message. The service insertion policy may include an address of a service border router for a service that is registered with the MS/MR. The computing device may send, to the first tunnel router, a message which indicates a map reply and includes the address of the service border router, for populating an overlay route in the first tunnel router to forward the communications via the service border router for insertion of the service. The service may be one of firewall or security service, a billing or an accounting service, an SLA monitoring service, or a QoS policy service, as a few examples.

On the other hand, when no service insertion policy exists, the computing device may select, from a mapping database, the second RLOC of the second tunnel router based on the second EID. The computing device may send, to the first tunnel router, the message which indicates the map reply and includes the second RLOC of the second tunnel router, for populating the route in the first tunnel router to forward the communications to the second tunnel router to the second host.

Prior to receiving the initial traffic of the communications from the first host, the computing device may receive, from the service border router, a message which indicates a service registration for registering the service with the MS/MR. In some implementations, service registration is performed by each one of a plurality of services available via the service border router. Here, the selecting of the service insertion policy may comprise selecting the service insertion policy from a plurality of service insertion policies respectively associated with the plurality of services registered with the MS/MR. In some implementations, the selecting of the service insertion policy from the plurality of service insertion policies may be performed according to a service ID associated with the service insertion policy or service.

In some implementations, the group identifier comprises an SGT, and the service insertion policy may be selected based on at least the SGT and a DGT associated with the second host. Here, the computing device may send, to the first tunnel router, the message which indicates the map reply and includes the address of the service border router, to further include the SGT, the DGT, and a group policy for application at the first tunnel router.

In some implementations, the service insertion policy further includes an instance ID associated with a VRF at the service border router. Here, the message which indicates the map reply may include the address of the service border router, a virtual network identifier of a virtual private network associated with the VRF, and the group identifier, for populating the overlay route in the first tunnel router to forward the communications, with encapsulation of the virtual network identifier and the group identifier, via the service border router for insertion of the service. In other implementations, the service insertion policy further includes a VLAN ID of a VLAN. Here, the message which indicates the map reply may include the address of the service border router, the VLAN ID, and the group identifier, for populating the overlay route in the first tunnel router to forward the communications, with encapsulation of the VLAN ID and the group identifier, via the service border router for insertion of the service.

Subsequently (i.e. after processing associated with the service), the computing device may receive, from the service border router, a message which indicates another map request for requesting an EID-to-RLOC mapping associated with the second EID. The computing device may select, from the mapping database, the second RLOC of the second tunnel router based on the second EID. The computing device may send, to the service border router, a message which indicates another map reply and includes the second RLOC of the second tunnel router, for populating an overlay route in the service border router to forward the communications via the second tunnel router to the second host.

Accordingly, in some implementations, the computing device may select either the service insertion policy or the second RLOC of the second tunnel router, based on identifying an indication (e.g. a message indication) of whether the message which indicates the map request or the other map request is sent from the first tunnel router or the service border router.

When the second host is a 5G endpoint which is located for communication via the second tunnel router that is external to the enterprise private network, the computing device may receive, from the service border router, a message which indicates another map request for requesting an EID-to-RLOC mapping associated with the second EID. The computing device may send, to the service border router, a message which indicates a second map reply and include a third RLOC of a border router, for populating an overlay route in the border router to the second host via the second tunnel router that is external to the enterprise private network.

Advantageously, when a service (or its associated path) becomes unavailable or is taken off-line, the service border router may send a message for service deregistration of the service. When the service (or its associated path) becomes available again or is brought back on-line, the service border router may again send a message for service registration for registration of the service. When a new or updated service becomes available, the service border router may send a message for service registration for registration of the new or updated service. As is apparent, the MS/MR may be updated dynamically for indicating the availability or non-availability of services. A plurality of service routers/service instances associated with a (e.g. single) service may register/deregister for load balancing and/or redundancy for the service.

In some implementations, the computing device of the present disclosure may include one or more processors, one or more interfaces to connect in an enterprise private network comprising an SDA or SDN fabric, and one or more memory elements for storing instructions executable on the one or more processors for operation as a MS/MR of a LISP control plane as described. In some other implementations, a computer program product may include a non-transitory computer readable medium and instructions stored on the non-transitory computer readable medium, where the instructions are executable by one or more processors of the computing device for operation as the MS/MR of the LISP control plane as described.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), VLAN, wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
at one or more computing devices which implement a map server/map resolver (MS/MR) of a Locator ID Separation Protocol (LISP) control plane for use in an enterprise private network, for facilitating communications from a first host that is located for communication via a first tunnel router to a second host that is located for communication via a second tunnel router, the first and the second hosts being assigned with first and second endpoint IDs (EIDs), respectively, and the first and the second tunnel routers being assigned with first and second routing locators (RLOCs), respectively,
receiving, from the first tunnel router, a message which indicates a map request for requesting an EID-to-RLOC mapping associated with the second EID, triggered in response to the first tunnel router receiving initial traffic of the communications from the first host;
selecting, from a policy database, a service insertion policy based on at least the second EID or a group identifier in the message, the service insertion policy including an address of a service border router for a service that is registered with the MS/MR; and
sending, to the first tunnel router, a message which indicates a map reply,
wherein the message which indicates the map reply includes the address of the service border router, for populating an overlay route in the first tunnel router to forward the communications via the service border router for insertion of the service.

2. The method of claim 1, further comprising:
at the one or more computing devices, prior to receiving the initial traffic of the communications from the first host,
receiving, from the service border router, a message which indicates a service registration for registering the service with the MS/MR.

3. The method of claim 1, wherein:
selecting the service insertion policy comprises selecting one of a plurality of service insertion policies respectively associated with a plurality of services available via the service border router and registered with the MS/MR.

4. The method of claim 1, further comprising:
if no service insertion policy for the communications exists,
selecting, from a mapping database, the second RLOC of the second tunnel router based on the second EID; and
wherein the message which indicates the map reply alternatively includes the second RLOC of the second tunnel router, for populating the overlay route in the first tunnel router to forward the communications via the second tunnel router to the second host.

5. The method of claim 1, wherein:
the group identifier comprises a source group tag (SGT), and
the service insertion policy is selected based on the SGT and a destination group tag (DGT) associated with the second host.

6. The method of claim 5, wherein:
sending, to the first tunnel router, the message which indicates the map reply and includes the address of the service border router, further includes the SGT, the DGT, and a group policy for application at the first tunnel router.

7. The method of claim 1, wherein:
the message which indicates the map reply includes the address of the service border router, a virtual network identifier of a virtual private network associated with a virtual routing and forwarding (VRF) at the service border router, and the group identifier, for populating the overlay route in the first tunnel router to forward the communications, with encapsulation of the virtual network identifier and the group identifier, via the service border router for insertion of the service.

8. The method of claim 1, wherein:
the message which indicates the map reply includes the address of the service border router, a virtual local area network (VLAN) ID of a VLAN, and the group identifier, for populating the overlay route in the first tunnel router to forward the communications, with encapsulation of the VLAN ID and the group identifier, via the service border router for insertion of the service.

9. The method of claim 1, further comprising:
at the one or more computing devices,
receiving, from the service border router, a message which indicates another map request for requesting an EID-to-RLOC mapping associated with the second EID; and
sending, to the service border router, a message which indicates another map reply and includes the second RLOC of the second tunnel router, for populating the overlay route in the service border router to forward the communications via the second tunnel router to the second host.

10. The method of claim 9, wherein:
selecting either the service insertion policy or the second RLOC of the second tunnel router, based on identifying an indication of whether the message which indicates the map request or the other map request is sent from the first tunnel router or the service border router.

11. The method of claim 1, wherein the second host comprises a Fifth Generation (5G) endpoint that is located for communication via the second tunnel router that is external to the enterprise private network, the method further comprising:
at the one or more computing devices,
receiving, from the service border router, a message which indicates another map request for requesting an EID-to-RLOC mapping associated with the second EID; and
sending, to the service border router, a message which indicates another map reply and includes a third RLOC of a border router, for populating the overlay route in the border router to the 5G endpoint via the second tunnel router that is external to the enterprise private network.

12. The method of claim 1, wherein the service comprises one of firewall or security service, a billing or an accounting service, a service level agreement (SLA) monitoring service, or a Quality of Service (QoS) policy service.

13. A computing device comprising:
one or more processors;
one or more interfaces to connect in a network for software-defined access (SDA) or software-defined networking (SDN);
one or more memory elements for storing instructions executable on the one or more processors for operation as a map server/map resolver (MS/MR) of a Locator ID Separation Protocol (LISP) control plane, for facilitating communications from a first host that is located for communication via a first tunnel router to a second host that is located for communication via a second tunnel router, the first and the second hosts being assigned with first and second endpoint IDs (EIDs), respectively, and the first and the second tunnel routers being assigned with first and second routing locators (RLOCs), respectively, the instructions being further executable for:
receiving, from the first tunnel router, a message which indicates a map request for requesting an EID-to-RLOC mapping associated with the second EID, triggered in response to the first tunnel router receiving initial traffic of the communications from the first host;
selecting, from a policy database, a service insertion policy based on at least the second EID or a group identifier in the message, the service insertion policy including an address of a service border router for a service that is registered with the MS/MR; and
sending, to the first tunnel router, a message which indicates a map reply,
wherein the message which indicates the map reply includes the address of the service border router, for populating an overlay route in the first tunnel router to forward the communications via the service border router for insertion of the service.

14. The computing device of claim 13, wherein the instructions are further executable on the one or more processors for:
for each one of a plurality of services available via the service border router, receiving, from the service border router, a message which indicates a service registration for registering the service with the MS/MR, and
wherein selecting the service insertion policy comprises selecting one of a plurality of service insertion policies respectively associated with the plurality of services registered with the MS/MR.

15. The computing device of claim 13, wherein:
the service insertion policy further includes an instance ID associated with a virtual routing and forwarding (VRF) at the service border router, and the message which indicates the map reply includes the address of the service border router, a virtual network identifier of a virtual private network associated with the VRF, and the group identifier, for populating the overlay route in the first tunnel router to forward the communications, with encapsulation of the virtual network identifier and the group identifier, via the service border router for insertion of the service, or
the service insertion policy further includes a virtual local area network (VLAN) ID of a VLAN, and the message which indicates the map reply includes the address of the service border router, the VLAN ID, and the group identifier, for populating the overlay route in the first tunnel router to forward the communications, with encapsulation of the VLAN ID and the group identifier, via the service border router for insertion of the service.

16. The computing device of claim 13, wherein the instructions are further executable on the one or more processors for:
receiving, from the service border router, a message which indicates another map request for requesting an EID-to-RLOC mapping associated with the second EID; and
sending, to the service border router, a message which indicates another map reply and includes the second RLOC of the second tunnel router, for populating the overlay route in the service border router to forward the communications via the second tunnel router to the second host,
wherein selecting either the service insertion policy or the second RLOC of the second tunnel router, based on identifying an indication of whether the message which indicates the map request or the other map request is sent from the first tunnel router or the service border router.

17. The computing device of claim 13, wherein the second host comprises a Fifth Generation (5G) endpoint that is located for communication via the second tunnel router that is external to the network, and wherein the instructions are further executable on the one or more processors for:
receiving, from the service border router, a message which indicates a second map request for requesting an EID-to-RLOC mapping; and
sending, to the service border router, a message which indicates a second map reply and includes a third RLOC of a border router, for populating the overlay route in the border router to forward the communications to the 5G endpoint via the second tunnel router that is external to the network.

18. A computer program product comprising a non-transitory computer readable medium and instructions stored on the non-transitory computer readable medium, where the instructions are executable by one or more processors of a computing device for operation as a map server/map resolver (MS/MR) of a Locator ID Separation Protocol (LISP) control plane for facilitating communications from a first host that is located for communication via a first tunnel router to a second host that is located for communication via a second tunnel router, the first and the second hosts being assigned with first and second endpoint IDs (EIDs), respectively, and the first and the second tunnel routers being assigned with first and second routing locators (RLOCs), respectively, the instructions being further executable for:
receiving, from the first tunnel router, a message which indicates a map request for requesting an EID-to-RLOC mapping associated with the second EID, triggered in response to the first tunnel router receiving initial traffic of the communications from the first host;
when no service insertion policy for the communications exists:
selecting, from a mapping database, the second RLOC of the second tunnel router based on the second EID;
sending, to the first tunnel router, a message which indicates a map reply, and includes the second RLOC of the second tunnel router for populating an overlay route in the first tunnel router to forward the communications via the second tunnel router to the second host;
when a service insertion policy for the communications exists:
selecting, from a policy database, the service insertion policy based on at least the second EID or a group identifier in the message, the service insertion policy including an address of a service border router for insertion of a service that is registered with the MS/MR; and
sending, to the first tunnel router, a message which indicates the map reply, and includes the address of the service border router, for populating the overlay route in the first tunnel router to forward the communications via the service border router for insertion of the service.

19. The computer program product of claim 18, wherein the instructions are further executable for:
for each one of a plurality of services available via the service border router, receiving, from the service border router, a message which indicates a service registration for registering the service with the MS/MR, and
wherein selecting the service insertion policy comprises selecting one of a plurality of service insertion policies respectively associated with the plurality of services registered with the MS/MR.

20. The computer program product of claim 18, wherein the instructions are further executable for:
when the service insertion policy for the communications exists:
receiving, from the service border router, a message which indicates another map request for requesting an EID-to-RLOC mapping; and
sending, to the service border router, a message which indicates another map reply and includes the second RLOC of the second tunnel router, for populating the overlay route in the service border router to forward the communications via the second tunnel router to the second host.
